(19) United States
(12) Patent Application Publication
(10) Pub. No.: US 2008/0043596 A1
(43) Pub. Date: Feb. 21, 2008

(54) OBJECTIVE LENS AND OPTICAL PICKUP APPARATUS

(76) Inventors: Kazutaka Noguchi, Tokyo (JP); Daisuke Tanahashi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/839,916

(22) Filed: Aug. 16, 2007

(30) Foreign Application Priority Data
Aug. 21, 2006 (JP) JP2006-224022

(51) Int. Cl. G11B 7/00

(52) U.S. Cl. 369/103

(57) ABSTRACT

The present invention provides an objective lens for use in an optical pickup apparatus for recording and/or reproducing information on an optical information recording medium using holography. The objective lens includes: a plurality of lens groups including three or more lens groups. In the objective lens, a first lens group closest to a light source of the optical pickup apparatus, includes an optical surface closest to the light source which is convex to a light source side.

This application is based on Japanese Patent Application No. 2006-224022 filed on Aug. 21, 2006, in Japanese Patent Office, the entire content of which is hereby incorporated by reference.

### TECHNICAL FIELD

The present invention relates to an objective lens to be used in an optical pickup apparatus that is installed in an optical information recording and/or reproducing apparatus employing holography, and to an optical pickup apparatus employing the objective lens.

### BACKGROUND

In recent years, there has been developed an optical pickup apparatus to be used for a holographic recording and/or reproducing apparatus that records and/or reproduces information for an optical information recording medium by using a holographic technique. As an objective lens to be loaded on the optical pickup apparatus, there is an objective lens having a construction of 1 element in 1 group in which aberration has been controlled to be low, as disclosed in Japanese Patent Publication Open to Public Inspection (JP-A) No. 2004-177839. Further, there is reported a technology to optimize a distance between an objective lens and an information recording medium through an astigmatism method which uses a wavelength that is different from a wavelength for recording and/or reproducing information and is not sensitive to hologram recording medium in the following article: Appl. Opt. Vol. 44, No. 13, P. 2575, Horimai et. al.

The technology in the above article allows an optical pickup apparatus to conduct focusing and tracking operations by using a light flux with a wavelength which is different from that for recording and/or reproducing information. However, when using light fluxes respectively with two types of wavelengths, it is necessary to converge the light fluxes having different wavelengths at desired positions without changing the distance between the objective lens and the information recording medium, and it is further necessary to correct suitably spherical aberration changed by a wavelength difference. Moreover, the smaller-sized objective lens reduces a load for an optical pickup apparatus, when the focusing and tracking operations is conducted.

However, JP-A No. 2004-177839 discloses neither about a miniaturizing the objective lens nor a method to optimize the distance between the objective lens and the information recording medium. Further, JP-A No. 2004-177839 provides neither a reference about an objective lens in which correction of chromatic aberration is considered nor a reference about a size of an optical system.

### SUMMARY

For aforesaid reasons, one of objects of the invention is to provide a small-sized objective lens for holographic recording and/or reproducing of optical information and an optical pickup apparatus employing the aforesaid objective lens. Another of objects of the invention is to provide a small-sized objective lens for holographic recording and/or reproducing of optical information that can form both of a light flux for recording and/or reproducing information and a light flux for focusing and tracking operations into images at desired focus positions, and has excellent light-converging capability, and to provide an optical pickup apparatus employing the aforesaid objective lens. Further, even when the optical pickup apparatus conducts recording and/or reproducing information and conducts the focusing and tracking operations using light fluxes with two types of wavelength, the present invention provides a small-sized objective lens for holographic recording and/or reproducing of optical information that can form a light flux with a wavelength different from the wavelength for recording and/or reproducing information into image at a desired focus position, with excellent light-converging capability, and to provide an optical pickup apparatus employing the aforesaid objective lens, which is another object of the invention.

To solve the aforesaid problems, the present invention provides an objective lens for use in an optical pickup apparatus for recording and/or reproducing information to an optical information recording medium using holography, in which the objective lens includes a plurality of lens groups including three or more lens groups. In the plurality of lens groups, a lens group closest to a light source of the optical pickup apparatus includes an optical surface closest to the light source being convex to the light source side.

These and other objects, features and advantages according to the present invention will become more apparent upon reading of the following detailed description along with the accompanied drawings.

### BRIEF DESCRIPTION OF THE DRAWINGS

Embodiments will now be described, by way of example only, with reference to the accompanying drawings which are meant to be exemplary, not limiting, and wherein like elements numbered alike in several Figures, in which:

FIG. 1 is a schematic configuration diagram of an optical pickup apparatus relating to an embodiment of the invention;

FIG. 2 is a cross-sectional view of an objective lens in Example 1 capable of being used in the optical pickup apparatus shown in FIG. 1;

FIG. 3 is a cross-sectional view of an objective lens in Example 1 capable of being used in the optical pickup apparatus shown in FIG. 1;

FIG. 4(a) is a diagram showing a curvature of field on a light-receiving element and FIG. 4(b) is a diagram showing a distortion on a light-receiving element, both in the case of reproducing hologram in Example 1;

FIG. 5 is a cross-sectional view of an objective lens in Example 2 capable of being used in the optical pickup apparatus shown in FIG. 1;

FIG. 6 is a cross-sectional view of an objective lens in Example 2 capable of being used in the optical pickup apparatus shown in FIG. 1;

FIG. 7(a) is a diagram showing a curvature of field on a light-receiving element and FIG. 7(b) is a diagram showing a distortion on a light-receiving element, both in the case of reproducing hologram in Example 2;

FIG. 8 is a cross-sectional view of an objective lens in Example 3 capable of being used in the optical pickup apparatus shown in FIG. 1;

FIG. 9 is a cross-sectional view of an objective lens in Example 3 capable of being used in the optical pickup apparatus shown in FIG. 1;

FIG. 10(a) is a diagram showing a curvature of field on a light-receiving element and FIG. 10(b) is a diagram showing a distortion on a light-receiving element, both in the case of reproducing hologram in Example 3;

FIG. 11 is a cross-sectional view of an objective lens in Example 4 capable of being used in the optical pickup apparatus shown in FIG. 1;

FIG. 12 is a cross-sectional view of an objective lens in Example 4 capable of being used in the optical pickup apparatus shown in FIG. 1;

FIG. 13(a) is a diagram showing a curvature of field on a light-receiving element and FIG. 13(b) is a diagram showing a distortion on a light-receiving element, both in the case of reproducing hologram in Example 4;

FIG. 14 is a cross-sectional view of an objective lens in Example 5 capable of being used in the optical pickup apparatus shown in FIG. 1;

FIG. 15 is a cross-sectional view of an objective lens in Example 5 capable of being used in the optical pickup apparatus shown in FIG. 1;

FIG. 16(a) is a diagram showing a curvature of field on a light-receiving element and FIG. 16(b) is a diagram showing a distortion on a light-receiving element, both in the case of reproducing hologram in Example 5.

FIG. 17 is a cross-sectional view of an objective lens in Example 6 capable of being used in the optical pickup apparatus shown in FIG. 1;

FIG. 18 is a cross-sectional view of an objective lens in Example 6 capable of being used in the optical pickup apparatus shown in FIG. 1;

FIG. 19(a) is a diagram showing a curvature of field on a light-receiving element and FIG. 19(b) is a diagram showing a distortion on a light-receiving element, both in the case of reproducing hologram in Example 6;

FIG. 20 is a cross-sectional view of an objective lens in Example 7 capable of being used in the optical pickup apparatus shown in FIG. 1;

FIG. 21 is a cross-sectional view of an objective lens in Example 7 capable of being used in the optical pickup apparatus shown in FIG. 1;

FIG. 22(a) is a diagram showing a curvature of field on a light-receiving element and FIG. 22(b) is a diagram showing a distortion on a light-receiving element, both in the case of reproducing hologram in Example 7;

FIG. 23 is a cross-sectional view of an objective lens in Example 8 capable of being used in the optical pickup apparatus shown in FIG. 1;

FIG. 24 is a cross-sectional view of an objective lens in Example 8 capable of being used in the optical pickup apparatus shown in FIG. 1;

FIG. 25(a) is a diagram showing a curvature of field on a light-receiving element and FIG. 25(b) is a diagram showing a distortion on a light-receiving element, both in the case of reproducing hologram in Example 8;

FIG. 26 is a cross-sectional view of an objective lens in Example 9 capable of being used in the optical pickup apparatus shown in FIG. 1;

FIG. 27 is a cross-sectional view of an objective lens in Example 9 capable of being used in the optical pickup apparatus shown in FIG. 1;

FIG. 28(a) is a diagram showing a curvature of field on a light-receiving element and FIG. 28(b) is a diagram showing a distortion on a light-receiving element, both in the case of reproducing hologram in Example 9;

FIG. 29 is a cross-sectional view of an objective lens in Example 10 capable of being used in the optical pickup apparatus shown in FIG. 1;

FIG. 30 is a cross-sectional view of an objective lens in Example 10 capable of being used in the optical pickup apparatus shown in FIG. 1;

FIG. 31(a) is a diagram showing a curvature of field on a light-receiving element and FIG. 31(b) is a diagram showing a distortion on a light-receiving element, both in the case of reproducing hologram in Example 10;

FIG. 32 is a cross-sectional view of an objective lens in Example 11 capable of being used in the optical pickup apparatus shown in FIG. 1;

FIG. 33 is a cross-sectional view of an objective lens in Example 11 capable of being used in the optical pickup apparatus shown in FIG. 1;

FIG. 34(a) is a diagram showing a curvature of field on a light-receiving element and FIG. 34(b) is a diagram showing a distortion on a light-receiving element, both in the case of reproducing hologram in Example 11;

FIG. 35 is a cross-sectional view of an objective lens in Example 12 capable of being used in the optical pickup apparatus shown in FIG. 1;

FIG. 36 is a cross-sectional view of an objective lens in Example 12 capable of being used in the optical pickup apparatus shown in FIG. 1;

FIG. 37(a) is a diagram showing a curvature of field on a light-receiving element and FIG. 34(b) is a diagram showing a distortion on a light-receiving element, both in the case of reproducing hologram in Example 12;

FIG. 38 is a cross-sectional view of an objective lens in Example 13 capable of being used in the optical pickup apparatus shown in FIG. 1;

FIG. 39 is a cross-sectional view of an objective lens in Example 13 capable of being used in the optical pickup apparatus shown in FIG. 1;

FIG. 40(a) is a diagram showing a curvature of field on a light-receiving element and FIG. 40(b) is a diagram showing a distortion on a light-receiving element, both in the case of reproducing hologram in Example 13;

FIG. 41 is a cross-sectional view of an objective lens in Example 14 capable of being used in the optical pickup apparatus shown in FIG. 1;

FIG. 42 is a cross-sectional view of an objective lens in Example 14 capable of being used in the optical pickup apparatus shown in FIG. 1;

FIG. 43(a) is a diagram showing a curvature of field on a light-receiving element and FIG. 43(b) is a diagram showing a distortion on a light-receiving element, both in the case of reproducing hologram in Example 14;

FIG. 44 is a cross-sectional view of an objective lens in Example 15 capable of being used in the optical pickup apparatus shown in FIG. 1;

FIG. 45 is a cross-sectional view of an objective lens in Example 15 capable of being used in the optical pickup apparatus shown in FIG. 1;

FIG. 46(a) is a diagram showing a curvature of field on a light-receiving element and FIG. 46(b) is a diagram showing a distortion on a light-receiving element, both in the case of reproducing hologram in Example 15;

FIG. 47 is a cross-sectional view of an objective lens in Example 16 capable of being used in the optical pickup apparatus shown in FIG. 1;

FIG. 48 is a cross-sectional view of an objective lens in Example 16 capable of being used in the optical pickup apparatus shown in FIG. 1;

FIG. 49(a) is a diagram showing a curvature of field on a light-receiving element and FIG. 49(b) is a diagram showing a distortion on a light-receiving element, both in the case of reproducing hologram in Example 16;

FIG. 50 is a cross-sectional view of an objective lens in Example 17 capable of being used in the optical pickup apparatus shown in FIG. 1;

FIG. 51 is a cross-sectional view of an objective lens in Example 17 capable of being used in the optical pickup apparatus shown in FIG. 1;

FIG. 52(a) is a diagram showing a curvature of field on a light-receiving element and FIG. 52(b) is a diagram showing a distortion on a light-receiving element, both in the case of reproducing hologram in Example 17;

FIG. 53 is a cross-sectional view of an objective lens in Example 18 capable of being used in the optical pickup apparatus shown in FIG. 1;

FIG. 54 is a cross-sectional view of an objective lens in Example 18 capable of being used in the optical pickup apparatus shown in FIG. 1.

FIG. 55(a) is a diagram showing a curvature of field on a light-receiving element and FIG. 55(b) is a diagram showing a distortion on a light-receiving element, both in the case of reproducing hologram in Example 18;

FIG. 56 is a cross-sectional view of an objective lens in Example 19 capable of being used in the optical pickup apparatus shown in FIG. 1;

FIG. 57 is a cross-sectional view of an objective lens in Example 19 capable of being used in the optical pickup apparatus shown in FIG. 1; and

FIG. 58(a) is a diagram showing a curvature of field on a light-receiving element and FIG. 58(b) is a diagram showing a distortion on a light-receiving element, both in the case of reproducing hologram in Example 19.

### DESCRIPTION OF THE PREFERRED EMBODIMENT

Preferred embodiments will be explained as follows. An objective lens relating to the present invention is an objective lens for use in an optical pickup apparatus for recording and/or reproducing information on an optical information recording medium using holography, and the objective lens comprises: a plurality of lens groups including three or more lens groups. In the objective lens, a first lens group closest to a light source of the optical pickup apparatus among the plurality of lens groups, comprises an optical surface closest to the light source being convex to a light source side.

Because three or more lens groups are employed, the objective lens relating to the invention makes it possible to restrain wavefront aberration not only for a ray of light traveling along the optical axis but also for a portion of a light flux which passes through the outer side of a spatial light modulator in the optical pickup apparatus and enters into a position having a large distance from the optical axis on the objective lens out of a light flux used for recording and/or reproducing information. Thereby, the resolution is enhanced over the whole area of an image formed by the objective lens for recording and/or reproducing information. Further, since the aforesaid first lens group includes an optical surface closest to the light source which is convex toward the light source side, this optical surface converges a light flux. Therefore, among respective lens groups where the converged light flux passes through, an optical surface with the largest effective diameter is the aforesaid surface. It means that the optical system of the objective lens is made to be small-sized, compared with an objective lens in which the first lens group includes the optical surface closest to the light source which is concave toward the light source side.

In the above objective lens, at least one lens group among the plurality of lens groups may have a different Abbe number from the other lens groups.

By employing a lens with different Abbe number for each lens group, the objective lens relating to the invention makes it possible to reduce a change in image forming capability of the objective lens when the wavelength of the light source shift. Further, when there is provided the objective lens used in an optical pickup apparatus for holographic recording and/or reproducing which conducts the focusing and tracking operations by using a light flux whose wavelength is different from that for recording and/or reproducing of information, it is possible to focus the light fluxes with different wavelengths on desired positions and to reduce spherical aberration that is varied by a different wavelength, compared with the Marechal's criterion, by employing, for example, lens materials which are different in terms of Abbe's number for a positive lens and a negative lens included in the lens groups in the objective lens. Meanwhile, in the present description, the lenses staying apart from each other with lens distance exceeding zero are regarded as different lens groups, while, lenses that are cemented to each other are regarded as one lens group.

The aforesaid objective lens may satisfy the following expression (1) where νp is an average of Abbe numbers of positive lenses in the plurality of lens groups, and

νn is an average of Abbe numbers of negative lenses in the plurality of lens groups.

21.9<|νp−νn| (1)

By satisfying the expression (1), it is possible to make a light flux for detecting distance between a hologram recording medium and the objective lens and for detecting a position of a hologram recording medium into a collimated light flux, and it improves an image forming performance of an objective lens for an off-axis light flux. Therefore, a lens-tilt margin when an objective lens is installed in an optical pickup apparatus grows greater, which is preferable.

Further, the aforesaid plurality of lens groups may include the first lens group closet to the light source which has a positive refractive power, and at least one lens group which has a negative refractive power. This makes it possible to prevent that a total length of an optical system grows to be too long, while keeping a working distance that is sufficiently long.

In particular, when the aforesaid plurality of lens groups consists of three lens groups, which are in order from the light source side: the first lens group having a positive refractive power; a second lens group having a negative refractive power; and a third lens group having a positive refractive power, a total length of an optical system does not grow to be too long, while keeping a longer working distance, which is preferable.

The aforesaid objective lens may also satisfy the following expression (2), where Pt is a refractive power of a whole of the objective lens, and P2 is a refractive power of a second lens group second closest to the light source.

−2.2<P2/Pt<0 (2)

When the power of the second lens group is smaller than the upper limit of the expression (2), eccentricity sensitivity can be restrained to be small, and when the power of the second lens group is greater than the lower limit of the expression, chromatic aberration can be corrected sufficiently, which is preferable.

The aforesaid objective lens may also satisfy the following expression (3), where Pt is a refractive power of a whole of the objective lens, and P2 is a refractive power of a second lens group second closest to the light source.

−2.2<P2/Pt≦−0.29 (3)

When the power of the second lens group is smaller than the upper limit of the expression (3), eccentricity sensitivity can be restrained to be small. When the power of the second lens group is greater than the lower limit, chromatic aberration can be corrected sufficiently, and in addition, the objective lens has a preferable structure to form a light flux for detecting information of a distance between a hologram recording medium and an objective lens (which corresponds to focusing adjustment) and detecting a positional information of a hologram recording medium (which corresponds to tracking adjustment) into a collimated light flux, which are preferable.

The aforesaid objective lens may also satisfy the following expression (4), where Pt is a refractive power of a whole of the objective lens, and P2 is a refractive power of a second lens group second closest to the light source.

−2.2<P2/Pt≦−0.39 (4)

When the power of the second lens group is smaller than the upper limit of the expression (4), eccentricity sensitivity can be restrained to be small. When the power of the second lens group is greater than the lower limit, chromatic aberration can be corrected sufficiently, and in addition, an image forming performance of the objective lens for an off-axis light flux is improved and a lens-tilt margin when the objective lens is installed in an optical pickup apparatus grows greater, which are preferable.

In the aforesaid objective lens, the first lens group may comprises a glass, and the optical surface closest to the light source in the first lens group may be polished spherically.

In the case of an aspheric surface lens manufactured through a glass molding method or an injection molding method, an optical surface of the aspheric surface lens generally includes slight distortion (surface roughness), compared with a spherically-polished glass lens manufactured by polishing its optical surface. The slight distortion is caused by a local error from a design value in the process of forming its metal mold. Therefore, when the first lens group is made of glass, and at least an optical surface closest to the light source is spherically polished, it allows to conduct recording and/or reproducing of information at a higher precision.

In the aforesaid objective lens, each of the plurality of lens groups may consist of one lens. In this case, a manufacturing cost can be reduced because the number of constituent lenses is small, which is preferable.

An optical pickup apparatus relating to the present invention is an optical pickup apparatus for reproducing information from an optical information recording medium including a recording layer and a guide layer or writing information to the optical information recording medium. The optical pickup apparatus includes: the objective lens of any one of above embodiments which is adopted to form a holographic image on the recording layer and to form a spot image on the guide layer.

Another optical pickup apparatus relating to the present invention is an optical pickup apparatus for reproducing information from an optical information recording medium including a recording layer or writing information to the optical information recording medium using holography caused by a reference light and an object light. The optical pickup apparatus includes: a first light source for emitting a first light flux with a wavelength λ1; a collimating lens for collimating the first light flux emitted from the first light source; and a first light splitting element for generating the reference light to be emitted on the recording layer out of the first light flux emitted by the collimating lens. The optical pickup apparatus further includes: a spatial light modulator for generating the object light from the first light flux emitted by the collimating lens; and the objective lens of any one of the above embodiments. The objective lens is adopted to converge the object light on the recording layer so as to form a holographic image on the recording layer using the object light and the reference light on the recording layer. The optical pickup apparatus further includes: a second light splitting element arranged on an optical path between the objective lens and the spatial light modulator for splitting out the first light flux reflected by the recording layer; and a photodetector for receiving the first light flux split out by the second light splitting element and for outputting information recorded on the recording layer.

Another optical pickup apparatus relating to the present invention as another embodiment is an optical pickup apparatus for reproducing information from an optical information recording medium including a recording layer and a guide layer or writing information to the optical information recording medium using holography caused by a reference light and an object light. The optical pickup apparatus includes: a first light source for emitting a first light flux with a wavelength λ1; a second light source for emitting a second light flux with a wavelength λ2; and a collimating lens for collimating the first light flux emitted from the first light source. The optical pickup apparatus further includes: a first light splitting element for generating the reference light to be emitted on the recording layer out of the first light flux emitted by the collimating lens; a spatial light modulator for generating the object light from the first light flux emitted by the collimating lens; and the objective lens of any one of above embodiments. The objective lens is adopted to converge the object light on the recording layer so as to form a holographic image on the recording layer using the object light and the reference light on the recording layer, and to form the second light flux into a spot image on the guide layer. The optical pickup apparatus further includes: a second light splitting element arranged on an optical path between the objective lens and the spatial light modulator for splitting out the first light flux reflected by the recording layer; and a first photodetector for receiving the first light flux split out by the second light splitting element and for outputting signal including information recorded on the recording layer. The optical pickup apparatus further includes: a third light splitting element arranged on an optical path between the objective lens and the second light source for splitting out the second light flux reflected by the guide layer; a second photodetector for receiving the second light flux split out by the third light splitting element and outputting signal including information recorded on the guide layer; and a drive device for driving the objective lens based on the signal outputted from the second photodetector.

In the present specification, “an objective lens” means a lens having a light converging function arranged at the closest position to the optical information recording medium with facing the optical information recording medium at the state that the optical information recording medium is loaded in an optical pickup apparatus. Further, when there is an optical element capable of being moved together with the aforesaid lens by an actuator, a lens group composed of this optical element and the aforesaid lens is “an objective lens for an optical pickup apparatus” in the present description.

The present invention provides a small-sized objective lens with high light-converging capability for holographic recording and/or reproducing optical information that can form a light flux for information recording and/or reproducing into an image at a desired focus position. The present invention further provides a small-sized objective lens with high light-converging capability for holographic recording and/or reproducing optical information that can form each of a light flux for information recording and/or reproducing and a light flux for the focusing and tracking operation into an image at a desired focus position. Furthermore, even when the optical pickup apparatus conducts information recording and/or reproducing and conducts the focusing and tracking operations using light fluxes with two types of wavelengths, the present invention provides a small-sized objective lens with high light-converging capability for holographic recording and/or reproducing optical information that can form a light flux with a wavelength different from the light flux for information recording and/or reproducing into an image at a desired focus position.

The preferred embodiment of the invention will be explained as follow, referring to the drawings.

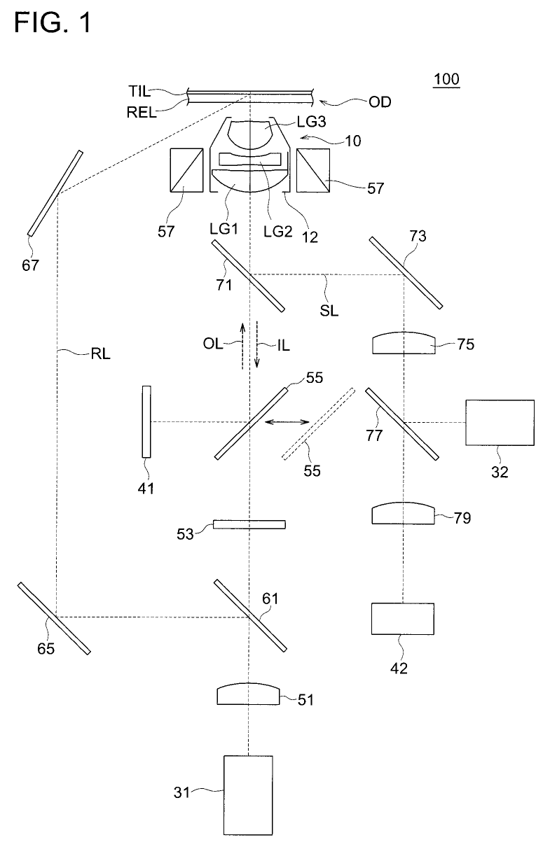

FIG. 1 shows a schematic and structural diagram of an optical pickup apparatus conducting recording and/or reproducing of information on an optical information recording medium by using holography. This optical pickup apparatus 100 is an apparatus of a holographic recording and reproducing type, and it is equipped with objective lens 10 for converging light that faces optical disc OD representing an optical information recording medium; first laser light source 31 representing a first light source (light source wavelength λ1) for recording and reproducing information; second laser light source 32 representing a second light source (light source wavelength: λ2>λ1) for servo operation; first optical detector 41 that receives information light IL coming from optical disc OD; and second optical detector 42 that receives servo light SL coming from optical disc OD.

Further, this optical pickup apparatus 100 is equipped with collimating lens 51 that converts object light OL coming from the first laser light source 31 into a collimated light flux; spatial light modulator 53 that gives appropriated two-dimensional light distribution to the object light OL; movable mirror 55 that switches between recording and reproducing of information; and biaxial actuator 57 for the focusing and tracking operations. In this case, half mirror 61 that splits out reference light RL through reflection is arranged between the first laser light source 31 and collimating lens 51, and a pair of mirrors 65 and 67 which reflect the reference light RL to guide it to optical disc OD from the side of objective lens 10.

Further, the optical pickup apparatus 100 is provided with dichroic mirror 71 that splits out servo light SL from a optical path of information light IL; mirror 73 for deflecting a optical path for the servo light SL; collimating lens 75 for forming a collimated light flux; half mirror 77 that splits servo light SL into a optical path toward the second laser light source 32 and a optical path toward the second photodetector 42; and cylindrical lens 79 that is arranged a optical path toward the second photodetector 42 and forms astigmatism.

Further, the optical pickup apparatus 100 has a light source driving circuit that operates first and second laser light sources 31 and 32 properly; a sensor driving circuit that operates first and second photodetectors 41 and 42 properly; and displacement driving circuit that operates biaxial actuator 57, though they are not illustrated.

In the optical pickup apparatus 100 in FIG. 1, objective lens 10 has first lens group LG1, second lens group LG2 and third lens group LG3 in this order from the light source side, and these first-third lens groups LG1-LG3 are united by holder 12 to be fixed, and they are driven by biaxial actuator 57 to be displaced slightly in the optical axis direction and in the tracking direction perpendicular to the optical axis direction. This objective lens 10 serves as a light converging optical system adopted to converge each of light fluxes coming respectively from both laser light sources 31 and 32 to a different depth of optical disc OD individually.

The first laser light sources 31 is provided to generating a light flux with first wavelength λ1 (specifically, for example, violet object light OL and violet reference light RL) as light for recording and reproducing, and the first laser light sources 31 makes it possible to reproduce hologram image information recorded on information recording layer REL that is formed on a surface side of optical disc OD, and/or to record hologram image information on the information recording layer REL. As the first laser light source 31, it is possible to use the second harmonic generation of YAG laser or a light source in which an outer resonator is used for a violet semiconductor laser to stabilize a frequency.

The second laser light sources 32 is provided for generating a light flux with second wavelength λ2 (specifically, for example, red servo light SL), and it makes it possible to detect positional information of a pit for servo operation recorded on tracking information surface TIL (guide layer) that is formed on the back side of optical disc OD, and it further enables focus-servo operation and tracking-servo operation. As the second laser light source 32, it is possible to use, for example, the red semiconductor laser.

The first photodetector 41 is an image sensor to detect information IL which has returned from information recording layer REL of optical disc OD, and the image sensor detects two-dimensional distribution in light and darkness of information light IL representing reading light ad two-dimensional image information, to output it. As this first photodetector 41, it is possible to use CCD image sensor and CMOS image sensor.

The second photodetector 42 is a sensor separated in four parts or the like for detecting servo light SL reflected on tracking information surface TIL of optical disc OD, and it detects focus error signals and tracking error signals based on servo light SL, to output them.

In the foregoing, the first laser light source 31 used for recording and/or reproducing of information, the first photodetector 41, collimating lens 51, spatial light modulator 53 and objective lens 10 are called the first optical system. Further, second laser light source 32 used for servo, the second photodetector 42, collimating lens 75, cylindrical lens 79 and objective lens 10 are called the second optical system.

Operations of optical pickup apparatus 100 shown in FIG. 1 will be explained as follows. To conduct recording information, a light flux is emitted from the first laser light source 31 for information recording and/or reproducing and is changed to a collimated light flux by collimating lens 51. Then, the light flux is split by half mirror 61 into light to be object light OL and light to be reference light RL. One of the light is converted by spatial light modulator 53 into two-dimensional page data as object light OL, and passes through mirror 71. The light then enters objective lens 10 to become a collimated light flux with narrowed in terms of a beam diameter. Object light OL emitted from objective lens 10 as a collimated light flux enters information recording layer REL representing a hologram recording medium, and records in the information recording layer interference fringes by interference with reference light RL entering from the side of the objective lens 10.

On the other hand, for reproducing information, movable mirror 55 of an aluminum-evaporation type is arranged on an optical path for object light OL. A light flux emitted from the first laser light source 31 is converted by collimating lens 51 into a collimated light flux, and then, is split by half mirror 61 into light to be object light OL and light to be reference light RL. However, when reproducing information, object light OL does not reach a hologram formed on information recording layer REL, because movable mirror 55 is arranged on the optical path, and only reference light RL arrives at a hologram on information recording layer REL, and thereby, a wavefront recorded here is reproduced. Information light IL which is reproduced on the information recording layer REL is reflected by a mirror layer provided on a back side of the information recording layer REL, then, it enters objective lens 10. The light passes through dichroic mirror 71, and enters the first photodetector 41 after being reflected by movable mirror 55. In other words, two-dimensional page data recorded on information recording layer REL are detected by the first photodetector 41.

In the foregoing process of recording and/or reproducing of information, objective lens 10 is held by biaxial actuator 57 to conduct focusing and tracking operations. In that case, servo light SL emitted from the second laser light source 32 passes through mirror 73 and is reflected by dichroic mirror 71 after being converted to a collimated light flux by collimating lens 75, and enters objective lens 10. A light flux converged by objective lens 10 passes through information recording layer REL and a mirror layer provided on the reverse side of the information recording layer REL, and is converged on tracking information surface TIL on which pits for servo are recorded. In other words, servo light SL with wavelength λ2 for tracking and focusing operations passes through a mirror layer on the back side of information recording layer REL, and is focused on tracking information surface TIL, while the objective lens 10 causes object light OL with wavelength λ1 for recording and/or reproducing to enter the information recording layer REL as a collimated light flux. Servo light SL modulated and reflected by pits for servo enters half mirror 77 through objective lens 10, dichroic mirror 71, mirror 73 and collimating lens 75. Servo light SL transmitted through half mirror 77 is given astigmatism by cylindrical lens 79, and enters the second photodetector 42. By detecting changes in a quantity of light caused by changes in a form and changes in a position of spots on the second photodetector 42, it is possible to conduct focus detection and track detection. Based on the results of these detections, biaxial actuator 57 installed in an optical head moves objective lens 10 in the optical axis direction so that servo light SL coming from the second laser light source 32 may form an image on tracking information surface TIL of optical disc OD, and moves objective lens 10 in the direction perpendicular to the optical axis direction so that servo light SL emitted from the second laser light source 32 may form an image on a prescribed track in the tracking information surface TIL. Owing to this, object light OL illuminated by the first laser light source 31 and emitted from spatial light modulator 53 passes through objective lens 10 and enters a prescribed area on information recording layer REL. Further, information light IL coming from a prescribed area on information recording layer REL is converged by objective lens 10 to enter the first photoconductor 41.

Incidentally, in the case of reproducing information, a series of sequences including, for example, tracking, focusing and confirming of written information are practiced, and these sequences can be changed properly, complying with application and specifications of optical pickup apparatus 100.

### EXAMPLES

Examples of the objective lens will be explained as follows. In specifications of an optical pickup apparatus of Examples, wavelength λ1 used for holographic recording and/or reproducing is 408 nm and wavelength λ2 used for tracking and focusing operations is 650 nm. In the following tables, r represents a paraxial curvature radius, d represents a distance between lens surfaces, n(λ1) represents a refractive index for λ1 and n(λ2) represents a refractive index for λ2. Hereinafter (including the lens data in the tables), the power of 10 will be expressed as by using “E”. For example, 2.5×10⁻³ will be expressed as 2.5E-3.

### Example 1

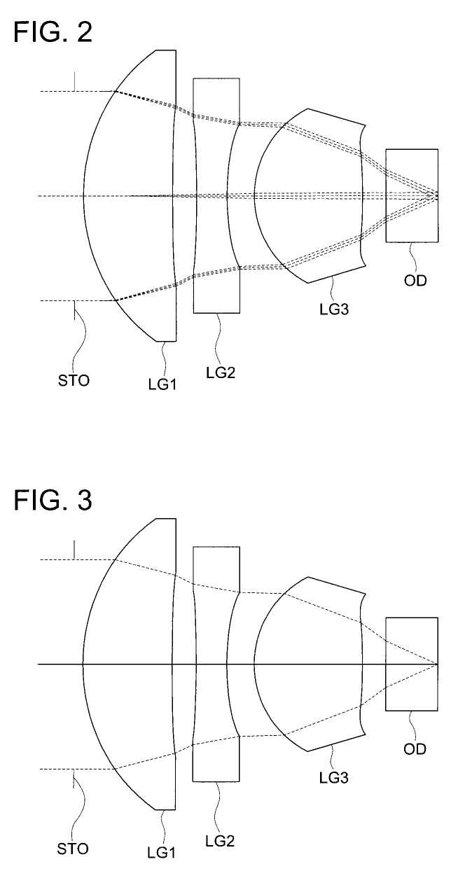

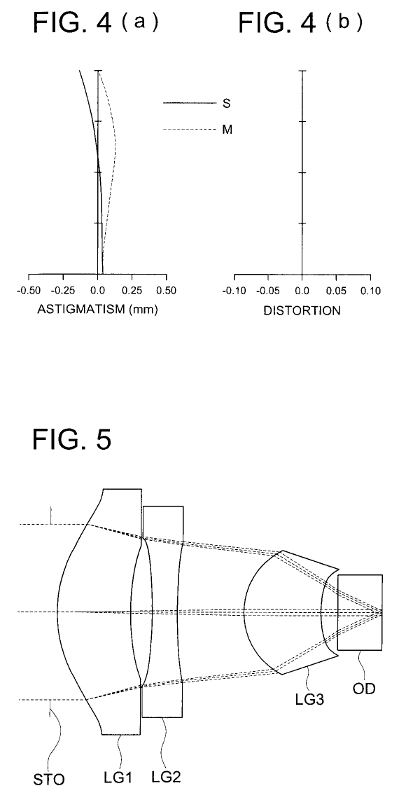

Each of FIG. 2 and FIG. 3 is a cross-sectional view relating to Example 1 of an objective lens that can be used for an optical pickup apparatus shown in FIG. 1. FIG. 2 shows an optical path for violet laser light (wavelength λ1) in the case of recording and/or reproducing of information, while, FIG. 3 shows an optical path for red laser light (wavelength λ2) for focusing and tracking operations. FIG. 4(a) is a diagram showing a curvature of the field on a light-receiving element and FIG. 4(b) is a diagram showing distortion on a light-receiving element, both in the case of reproducing hologram in the present example. In the diagram of the curvature of the field, broken lines M and solid lines S indicate astigmatism (mm) on a meridional image surface and a saggital surface respectively. Further, in the diagram of distortion, the solid lines indicate distortion (%). In each of FIG. 2 and FIG. 3, the objective lens has therein positive first lens group LG1, negative second lens group LG2 and positive third lens group LG3 in this order from the light source side, and a light source side optical surface of the first lens group LG1 that is closest to the light source is convex toward the light source side.

In FIG. 2, a spatial light modulator is arranged at the position of diaphragm STO, or a relay lens is arranged so that an image of the spatial light modulator may be formed at this position. A diffraction angle of a light flux diffracted by a cell of the spatial light modulator is dependent on a size of the cell, and a diffraction angle was set to 0.86° in the present example. A light flux with wavelength λ1 entering from the spatial light modulator changes into a collimated light flux after being transmitted through an objective lens, and it records interference fringes formed through interference with reference light on hologram recording medium OD.

On the other hand, as for a light flux with wavelength λ2 for tracking and focusing operations, its optical path is adjusted to a light flux with wavelength λ1 by a dichroic mirror, and then, the light flux is restricted by diaphragm STO, thus the light flux converged by the objective lens is transmitted through a hologram recording layer to be focused on a layer on which pits for servo operation are recorded.

In Table 1, (a) represents lens data, (b) represents aspheric surface data, (c) represents wavefront aberration data on a light flux with wavelength λ1 having passed through the first optical system at the image height portions provided by dividing the image height into 10 portions at the position of diaphragm STO, and (d) represents wavefront aberration data on a light flux with wavelength λ2 having passed through the second optical system. When a light flux with wavelength λ1 passes through an objective lens, a maximum object height is −0.61 mm, NA on the object side is 0.015 and a focal length is 1 mm. On the other hand, when a light flux with wavelength λ2 passes through an objective lens, a diaphragm diameter is 1.23 mm and NA on the object side is 0.6. In the present example, P2/Pt=−0.933 and |νp−νn|=31.65 hold.

In Table 1, (c) indicates that wavefront aberration of a light flux with wavelength λ1 having passed through the first optical system at each image height portion at the position of diaphragm STO is properly corrected. Further, (d) in Table 1 indicates that wavefront aberration of a light flux with wavelength λ2 having passed through the second optical system is properly corrected.

TABLE 1
(a) Lens data table

| | | d | d | | | | | |
|---|---|---|---|---|---|---|---|---|
| Surface | | (Optical | (Optical | | | | | |
| No. | r | system 1) | system 2) | n(λ1) | n(λ2) | nd | νd | Remarks |
| 0 | — | 0 | ∞ | | | | | |
| STO | ∞ | 0.050 | 0.050 | | | | | Diaphragm |
| 2 | 1.08669 | 0.490 | 0.490 | 1.798236 | 1.768168 | 1.7725 | 49.6 | TAF1_HOYA |
| 3 | 7.72058 | 0.140 | 0.140 | | | | | |
| 4 | −5.9432 | 0.170 | 0.170 | 1.911736 | 1.837276 | 1.8466 | 23.8 | FDS90_HOYA |
| 5 | 1.18585 | 0.160 | 0.160 | | | | | |
| 6 | 0.49895 | 0.630 | 0.630 | 1.604728 | 1.586417 | 1.58913 | 61.3 | MBACD5N_HOYA |
| 7 | −1.16334 | 0.130 | 0.130 | | | | | |
| 8 | ∞ | 0.300 | 0.300 | 1.506074 | 1.489154 | — | — | Hologram |
| | | | | | | | | recording |
| | | | | | | | | medium |
| 9 | ∞ | 0 | 0 | | | | | |

(b) Aspheric surface data

| | 6^{th} surface | 7^{th} surface |
|---|---|---|
| k | −1.41484E−01 | −9.35685E+00 |
| A4 | −3.07389E−01 | 3.25395E+00 |
| A6 | −4.99527E−01 | −2.16612E+01 |
| A8 | −2.58537E+00 | 1.34787E+02 |
| A10 | 7.66022E−01 | −7.26835E+01 |
| A12 | −1.45336E+01 | −5.19321E−02 |

(c) Wavefront aberration data of optical system 1 (λ1)

| Image height | Wavefront aberration |
|---|---|
| (mm) | (λrms) |
| 0.00 | 0.003 |
| 0.06 | 0.003 |
| 0.12 | 0.004 |
| 0.18 | 0.005 |
| 0.24 | 0.006 |
| 0.30 | 0.008 |
| 0.37 | 0.009 |
| 0.43 | 0.009 |
| 0.49 | 0.008 |
| 0.55 | 0.008 |
| 0.61 | 0.009 |

(d) Wavefront aberration data of optical system 2 (λ2)

| | Wavefront aberration |
|---|---|
| | (λrms) |
| Optical | 0.002 |
| system 2 | |

In Example 1, the 5^{th} surface and the 6^{th} surface only are made to be an aspheric surface, which is apparent from aspheric surface data in Table 1 showing conic constant κ and aspheric surface coefficient A2i of each surface. In this case, a form of the aspheric surface is given by the following expression of Expression 10, under the following assumptions.
x: Distance from a tangential plane on a vertex of the aspheric surface to the point on the aspheric surface whose height from optical axis is h
h: Height from an optical axis
c: Curvature at the vertex of aspheric surface (=1/r)
κ: Conic constant
A2i: (2i)^{th} aspheric surface coefficient where i is a natural number of 2 or more

$$x = \frac{{h}^{2} / r}{1 + \sqrt{1 - ( 1 + κ ) {h}^{2} / {r}^{2}}} + {\sum }_{t = 2} {A}_{2 t} {h}^{2 t} \qquad ( 10 )$$

### Example 2

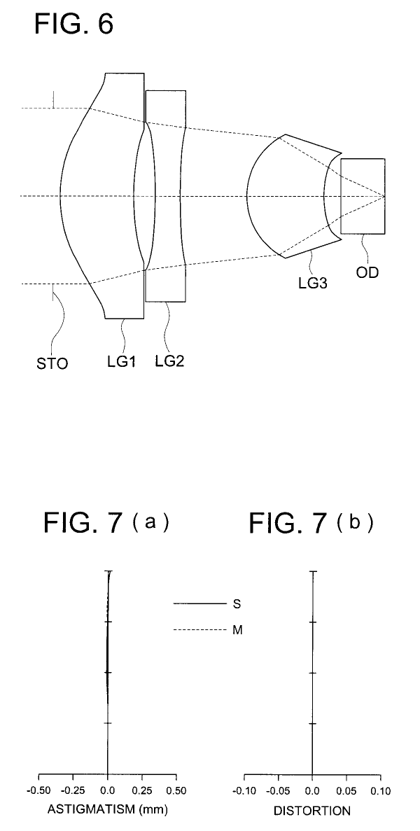

Each of FIG. 5 and FIG. 6 is a cross-sectional view relating to Example 2 of an objective lens capable of being used for an optical pickup apparatus shown in FIG. 1. FIG. 5 shows an optical path of a violet laser light (wavelength λ1) in the case of recording and/or reproducing of information, while, FIG. 6 shows an optical path of a red laser light (wavelength λ2) for focusing and tracking operations. FIG. 7(a) is a diagram showing a curvature of the field on a light-receiving element and FIG. 7(b) is a diagram showing distortion on a light-receiving element, both in the case of reproducing hologram in the present example. In each of FIG. 5 and FIG. 6, an objective lens has therein positive first lens group LG1, negative second lens group LG2 and positive third lens group LG3 in this order from the light source side, and a light source side optical surface of the first lens group LG1 that is closest to the light source is convex toward the light source side.

In FIG. 5, a spatial light modulator is arranged at the position of diaphragm STO, or a relay lens is arranged so that an image of the spatial light modulator may be formed at this position. A diffraction angle of a light flux diffracted by a cell of the spatial light modulator is dependent on a size of the cell, and a diffraction angle was set to 0.86° in the present example. A light flux with wavelength λ1 entering from the spatial light modulator changes into a collimated light flux after being transmitted through an objective lens, and it records interference fringes formed through interference with reference light, on hologram recording medium OD.

On the other hand, as for a light flux with wavelength λ2 for tracking and focusing operations, its optical path is adjusted to a light flux with wavelength λ1 by a dichroic mirror, and then, the light flux is restricted by diaphragm STO, thus the light flux converged by the objective lens is transmitted through a hologram recording layer to be focused on a layer on which pits for servo are recorded.

In Table 2, (a) represents lens data, (b) represents aspheric surface data, (c) represents wavefront aberration data on a light flux with wavelength λ1 having passed through the first optical system at the image height portions provided by dividing the image height into 10 portions at the position of diaphragm STO, and (d) represents wavefront aberration data on a light flux with wavelength λ2 having passed through the second optical system. When a light flux with wavelength λ1 passes through an objective lens, a maximum object height is −0.61 mm, NA on the object side is 0.015 and a focal length is 1 mm. On the other hand, when a light flux with wavelength λ2 passes through an objective lens, a diaphragm diameter is 1.23 mm and NA on the object side is 0.6. In the present example, P2/Pt=−0.492 and |νp−νn|=1.50 hold.

In Table 2, (c) indicates that wavefront aberration of a light flux with wavelength λ1 having passed through the first optical system at each image height portion at the position of diaphragm STO is properly corrected. Further, (d) in Table 1 indicates that wavefront aberration of a light flux with wavelength λ2 having passed through the second optical system is properly corrected.

TABLE 2
(a) Lens data table

| | | d | d | | | | | |
|---|---|---|---|---|---|---|---|---|
| Surface | | (Optical | (Optical | | | | | |
| No. | r | system 1) | system 2) | n(λ1) | n(λ2) | nd | νd | Remarks |
| 0 | — | 0 | −32.435 | | | | | |
| STO | ∞ | 0.050 | 0.050 | | | | | Diaphragm |
| 2 | 0.90502 | 0.490 | 0.490 | 1.839654 | 1.800681 | 1.806105 | 40.7 | NBFD13_HOYA |
| 3 | 1.01706 | 0.160 | 0.160 | | | | | |
| 4 | −2.16460 | 0.170 | 0.170 | 1.621761 | 1.59138 | 1.59551 | 39.2 | EF8_HOYA |
| 5 | 3.12838 | 0.460 | 0.460 | | | | | |
| 6 | 0.42953 | 0.530 | 0.530 | 1.839654 | 1.800681 | 1.806105 | 40.7 | NBFD13_HOYA |
| 7 | 0.76295 | 0.120 | 0.120 | | | | | |
| 8 | ∞ | 0.300 | 0.300 | 1.506074 | 1.489154 | — | — | Hologram |
| | | | | | | | | recording |
| | | | | | | | | medium |
| 9 | ∞ | 0 | 0 | | | | | |

(b) Aspheric surface data

| | 2^{nd} surface | 3^{rd} surface | 6^{th} surface | 7^{th} surface |
|---|---|---|---|---|
| k | −8.56861E−01 | −4.75187E+00 | −2.59209E−01 | −6.71334E+00 |
| A4 | −3.90702E−02 | −2.47506E−01 | −3.98475E−01 | 5.31721E+00 |
| A6 | −7.34195E−02 | −7.51224E−01 | −7.49546E−03 | 1.41412E+01 |
| A8 | −4.03770E−02 | 4.61745E−01 | −3.58536E+00 | −1.96473E+02 |
| A10 | −2.59652E−01 | 3.28282E−01 | 6.78732E+00 | 6.58937E+03 |
| A12 | — | — | −2.31418E+01 | −5.20732E−02 |

(c) Wavefront aberration data of optical system 1 (λ1)

| Image height | Wavefront aberration |
|---|---|
| (mm) | (λrms) |
| 0.00 | 0.000 |
| 0.06 | 0.000 |
| 0.12 | 0.000 |
| 0.18 | 0.000 |
| 0.24 | 0.000 |
| 0.30 | 0.001 |
| 0.37 | 0.001 |
| 0.43 | 0.001 |
| 0.49 | 0.001 |
| 0.55 | 0.000 |
| 0.61 | 0.001 |

(d) Wavefront aberration data of optical system 2 (λ2)

| | Wavefront aberration |
|---|---|
| | (λrms) |
| Optical | 0.000 |
| system 2 | |

In Example 2, th 1^{st} surface, the 2^{nd} surface, the 5^{th} surface and the 6^{th} surface only are made to be an aspheric surface, which is apparent from aspheric surface data in Table 2 showing conic constant κ and aspheric surface coefficient A2i of each surface.

### Example 3

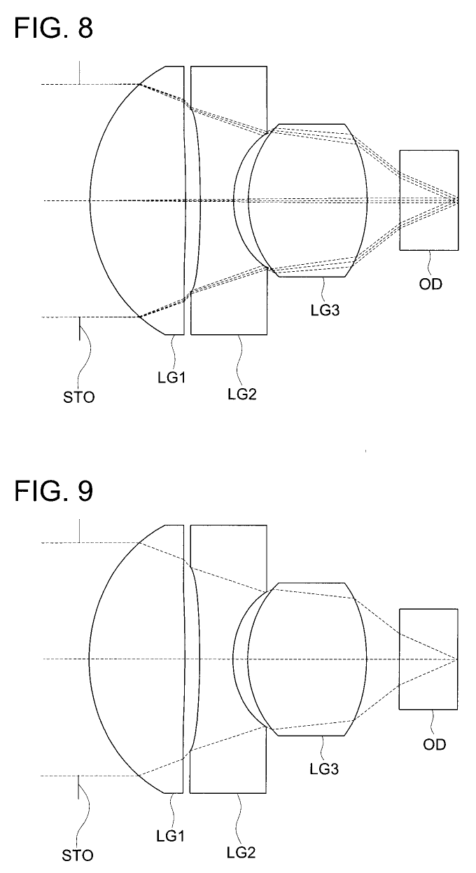

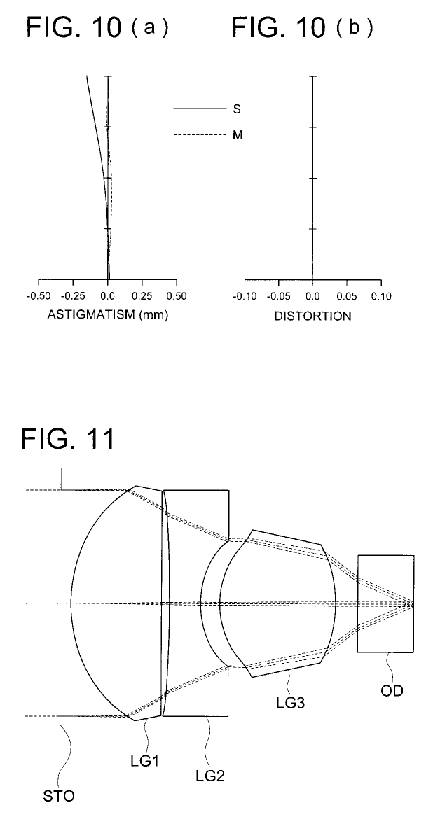

Each of FIG. 8 and FIG. 9 is a cross-sectional view relating to Example 3 of an objective lens capable of being used for an optical pickup apparatus shown in FIG. 1. FIG. 8 shows an optical path of a violet laser light (wavelength λ1) in the case of recording and/or reproducing of information, while, FIG. 9 shows an optical path of a red laser light (wavelength λ2) for focusing and tracking. FIG. 10(a) is a diagram showing a curvature of the field on a light-receiving element and FIG. 10(b) is a diagram showing distortion on a light-receiving element, both in the case of reproducing hologram in the present example. In each of FIG. 8 and FIG. 9, an objective lens has therein positive first lens group LG1, negative second lens group LG2 and positive third lens group LG3 in this order from the light source side, and a light source side optical surface of the first lens group LG1 that is closest to the light source is convex toward the light source side.

In FIG. 8, a spatial light modulator is arranged at the position of diaphragm STO, or a relay lens is arranged so that an image of the spatial light modulator may be formed at this position. A diffraction angle of a light flux diffracted by a cell of the spatial light modulator is dependent on a size of the cell, and a diffraction angle was set to 0.86° in the present example. A light flux with wavelength λ1 entering from the spatial light modulator changes into a collimated light flux after being transmitted through an objective lens, and it records interference fringes formed through interference with reference light on hologram recording medium OD.

On the other hand, as for a light flux with wavelength λ2 for tracking and focusing operations, its optical path is adjusted to a light flux with wavelength λ1 by a dichroic mirror, and then, the light flux is restricted by diaphragm STO, thus the light flux converged by the objective lens is transmitted through a hologram recording layer to be focused on a layer on which pits for servo are recorded.

In Table 3, (a) represents lens data, (b) represents aspheric surface data, (c) represents wavefront aberration data on a light flux with wavelength λ1 having passed through the first optical system at the image height resulted from 10-split at the position of diaphragm STO, and (d) represents wavefront aberration data on a light flux with wavelength λ2 having passed through the second optical system. When a light flux with wavelength λ1 passes through an objective lens, a maximum object height is −0.61 mm, NA on the object side is 0.015 and a focal length is 1 mm. On the other hand, when a light flux with wavelength λ2 passes through an objective lens, a diaphragm diameter is 1.23 mm and NA on the object side is 0.6. In the present example, P2/Pt=−2.110 and |νp−νn|=21.95 hold.

In Table 3, (c) indicates that wavefront aberration of a light flux with wavelength λ1 having passed through the first optical system at each image height portion at the position of diaphragm STO is properly corrected. Further, (d) in Table 1 indicates that wavefront aberration of a light flux with wavelength λ2 having passed through the second optical system is properly corrected.

TABLE 3
(a) Lens data table

| | | d | d | | | | | |
|---|---|---|---|---|---|---|---|---|
| Surface | | (Optical | (Optical | | | | | |
| No. | r | system 1) | system 2) | n(λ1) | n(λ2) | nd | νd | Remarks |
| 0 | — | 0 | ∞ | | | | | |
| STO | ∞ | 0.050 | 0.050 | | | | | Diaphragm |
| 2 | 0.82655 | 0.490 | 0.490 | 1.798236 | 1.768168 | 1.7725 | 49.6 | TAF1_HOYA |
| 3 | −14.80524 | 0.070 | 0.070 | | | | | |
| 4 | −2.67771 | 0.170 | 0.170 | 1.774371 | 1.721399 | 1.72625 | 28.3 | EFD10_HOYA |
| 5 | 0.43305 | 0.080 | 0.080 | | | | | |
| 6 | 0.47186 | 0.630 | 0.630 | 1.680069 | 1.489154 | 1.658436 | 50.9 | BACED5_HOYA |
| 7 | −0.69017 | 0.170 | 0.170 | | | | | |
| 8 | ∞ | 0.300 | 0.300 | 1.506074 | 1.489154 | — | — | Hologram |
| | | | | | | | | recording |
| | | | | | | | | medium |
| 9 | ∞ | 0 | 0 | | | | | |

(b) Aspheric surface data

| | 2^{nd} surface | 3^{rd} surface | 4^{th} surface | 5^{th} surface | 6^{th} surface | 7^{th} surface |
|---|---|---|---|---|---|---|
| k | −3.10482E−02 | −1.09999E+01 | −1.28087E+00 | −5.81227E−02 | −3.87767E−01 | −1.30717E−01 |
| A4 | −4.47174E−03 | −1.10512E−01 | 1.60533E−02 | −1.81771E−02 | −6.48492E−01 | 1.31752E+00 |
| A6 | −8.13468E−02 | 1.21242E−02 | 6.87789E−02 | −8.21938E−01 | −1.32840E+00 | −1.54509E+01 |
| A8 | −1.30437E−01 | 2.08596E+00 | 3.91140E−01 | −6.23443E+00 | −1.16588E+01 | 1.28040E+02 |
| A10 | 5.48564E−01 | −3.06217E+00 | −2.95634E−01 | −8.07492E+01 | −3.86971E+01 | −6.77058E+02 |
| A12 | — | — | — | — | 1.91166E+02 | 1.50876E+03 |

(c) Wavefront aberration data of optical system 1 (λ1)

| Image height | Wavefront aberration |
|---|---|
| (mm) | (λrms) |
| 0.00 | 0.001 |
| 0.06 | 0.001 |
| 0.12 | 0.001 |
| 0.18 | 0.002 |
| 0.24 | 0.002 |
| 0.30 | 0.003 |
| 0.37 | 0.004 |
| 0.43 | 0.005 |
| 0.49 | 0.007 |
| 0.55 | 0.009 |
| 0.61 | 0.011 |

(d) Wavefront aberration data of optical system 2 (λ2)

| | Wavefront aberration |
|---|---|
| | (λrms) |
| Optical | 0.000 |
| system 2 | |

In Example 3, all of the 1^{st}-6^{th} surfaces are made to be an aspheric surface, which is apparent from aspheric surface data in Table 3 showing conic constant κ and aspheric surface coefficient A2i of each surface.

### Example 4

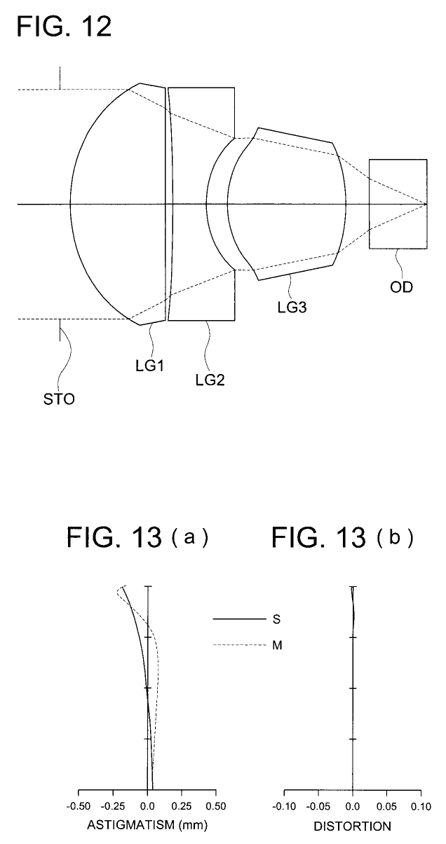

Each of FIG. 11 and FIG. 12 is a cross-sectional view relating to Example 4 of an objective lens capable of being used for an optical pickup apparatus shown in FIG. 1. FIG. 11 shows an optical path of a violet laser light (wavelength λ1) in the case of recording and/or reproducing of information, while, FIG. 12 shows an optical path of a red laser light (wavelength λ2) for focusing and tracking. FIG. 13(a) is a diagram showing a curvature of the field on a light-receiving element and FIG. 13(b) is a diagram showing distortion on a light-receiving element, both in the case of reproducing hologram in the present embodiment. In each of FIG. 11 and FIG. 12, an objective lens has therein positive first lens group LG1, negative second lens group LG2 and positive third lens group LG3 in this order from the light source side, and a light source side optical surface of the first lens group LG1 that is closest to the light source is convex toward the light source side.

In FIG. 11, a spatial light modulator is arranged at the position of diaphragm STO, or a relay lens is arranged so that an image of the spatial light modulator may be formed at this position. A diffraction angle of a light flux diffracted by a cell of the spatial light modulator is dependent on a size of the cell, and a diffraction angle was set to 0.86° in the present example. A light flux with wavelength λ1 entering from the spatial light modulator changes into a collimated light flux after being transmitted through an objective lens, and it records interference fringes formed through interference with reference light, on hologram recording medium OD.

On the other hand, as for a light flux with wavelength λ2 for tracking and focusing operations, its optical path is adjusted to a light flux with wavelength λ1 by a dichroic mirror, and then, the light flux is restricted by diaphragm STO, thus the light flux converged by the objective lens is transmitted through a hologram recording layer to be focused on a layer on which pits for servo are recorded.

In Table 4, (a) represents lens data, (b) represents aspheric surface data, (c) represents wavefront aberration data on a light flux with wavelength λ1 having passed through the first optical system at the image height portions provided by dividing the image height into 10 portions at the position of diaphragm STO, and (d) represents wavefront aberration data on a light flux with wavelength λ2 having passed through the second optical system. When a light flux with wavelength λ1 passes through an objective lens, a maximum object height is −0.61 mm, NA on the object side is 0.015 and a focal length is 1 mm. On the other hand, when a light flux with wavelength λ2 passes through an objective lens, a diaphragm diameter is 1.23 mm and NA on the object side is 0.6. In the present example, P2/Pt=−2.025 and |νp−νn|=25.75 hold.

In Table 4, (c) indicates that wavefront aberration of a light flux with wavelength λ1 having passed through the first optical system at each image height portion at the position of diaphragm STO is properly corrected. Further, (d) in Table 1 indicates that wavefront aberration of a light flux with wavelength λ2 having passed through the second optical system is properly corrected.

TABLE 4
(a) Lens data table

| | | d | d | | | | | |
|---|---|---|---|---|---|---|---|---|
| Surface | | (Optical | (Optical | | | | | |
| No. | r | system 1) | system 2) | n(λ1) | n(λ2) | nd | νd | Remarks |
| 0 | — | 0 | ∞ | | | | | |
| STO | ∞ | 0.050 | 0.050 | | | | | Diaphragm |
| 2 | 0.75867 | 0.490 | 0.490 | 1.798236 | 1.768168 | 1.7725 | 49.6 | TAF1_HOYA |
| 3 | 62.02335 | 0.040 | 0.040 | | | | | |
| 4 | −7.18585 | 0.170 | 0.170 | 1.869351 | 1.812876 | 1.820268 | 29.7 | MNBFD83_HOYA |
| 5 | 0.46155 | 0.110 | 0.110 | | | | | |
| 6 | 0.42538 | 0.630 | 0.630 | 1.604728 | 1.586417 | 1.58913 | 61.3 | MBACD5N_HOYA |
| 7 | −0.67392 | 0.120 | 0.120 | | | | | |
| 8 | ∞ | 0.300 | 0.300 | 1.506074 | 1.489154 | — | — | Hologram |
| | | | | | | | | recording |
| | | | | | | | | medium |
| 9 | ∞ | 0 | 0 | | | | | |

(b) Aspheric surface data

| | 6^{th} surface | 7^{th} surface |
|---|---|---|
| k | −2.46810E−01 | −1.00038E−02 |
| A4 | −9.28322E−01 | 2.75417E+00 |
| A6 | −2.62048E+00 | −2.95884E+01 |
| A8 | −5.07552E+01 | 9.00859E+01 |
| A10 | 2.84809E+02 | 1.22187E+02 |
| A12 | −1.84216E+03 | −5.69643E−02 |

(c) Wavefront aberration data of optical system 1 (λ1)

| Image height | Wavefront aberration |
|---|---|
| (mm) | (λrms) |
| 0.00 | 0.003 |
| 0.06 | 0.003 |
| 0.12 | 0.003 |
| 0.18 | 0.004 |
| 0.24 | 0.004 |
| 0.30 | 0.005 |
| 0.37 | 0.006 |
| 0.43 | 0.006 |
| 0.49 | 0.006 |
| 0.55 | 0.010 |
| 0.61 | 0.013 |

(d) Wavefront aberration data of optical system 2 (λ2)

| | Wavefront aberration |
|---|---|
| | (λrms) |
| Optical | 0.007 |
| system 2 | |

In Example 4, the 5^{th} surface and the 6^{th} surface only are made to be an aspheric surface, which is apparent from aspheric surface data in Table 4 showing conic constant κ and aspheric surface coefficient A2i of each surface.

### Example 5

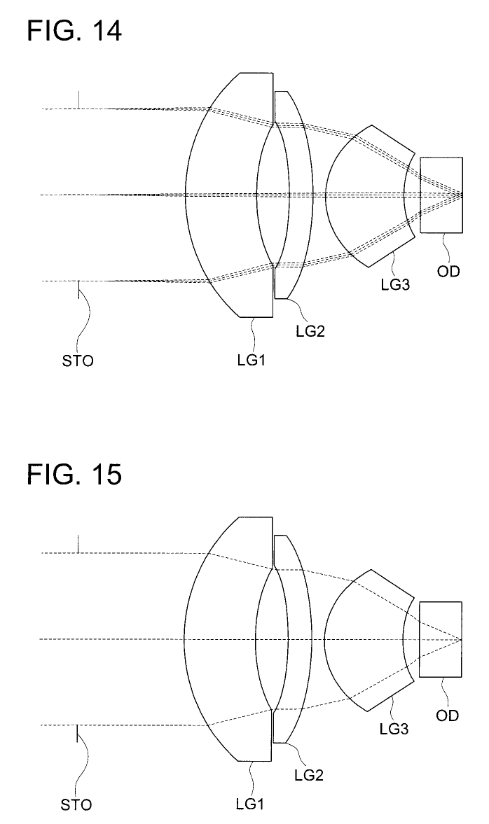

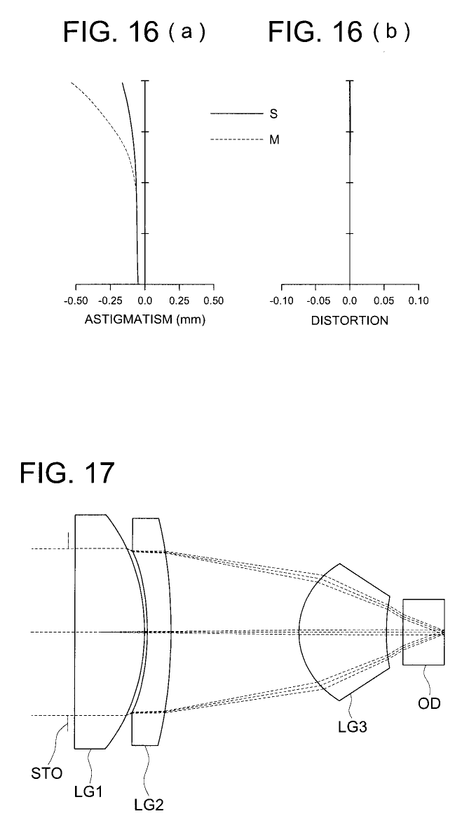

Each of FIG. 14 and FIG. 15 is a cross-sectional view relating to Example 5 of an objective lens capable of being used for an optical pickup apparatus shown in FIG. 1. FIG. 14 shows an optical path of a violet laser light (wavelength λ1) in the case of recording and/or reproducing of information, while, FIG. 15 shows an optical path of a red laser light (wavelength λ2) for focusing and tracking. FIG. 16(a) is a diagram showing a curvature of the field on a light-receiving element and FIG. 16(b) is a diagram showing distortion on a light-receiving element, both in the case of reproducing hologram in the present embodiment. In each of FIG. 14 and FIG. 15, an objective lens has therein positive first lens group LG1, negative second lens group LG2 and positive third lens group LG3 in this order from the light source side, and a light source side optical surface of the first lens group LG1 that is closest to the light source is convex toward the light source side.

In FIG. 14, a spatial light modulator is arranged at the position of diaphragm STO, or a relay lens is arranged so that an image of the spatial light modulator may be formed at this position. A diffraction angle of a light flux diffracted by a cell of the spatial light modulator is dependent on a size of the cell, and a diffraction angle was set to 0.86° in the present example. A light flux with wavelength λ1 entering from the spatial light modulator changes into a collimated light flux after being transmitted through an objective lens, and it records interference fringes formed through interference with reference light, on hologram recording medium OD.

On the other hand, as for a light flux with wavelength λ2 for tracking and focusing operations, its optical path is adjusted to a light flux with wavelength λ1 by a dichroic mirror, and then, the light flux is restricted by diaphragm STO, thus the light flux converged by the objective lens is transmitted through a hologram recording layer to be focused on a layer on which pits for servo are recorded.

In Table 5, (a) represents lens data, (b) represents aspheric surface data, (c) represents wavefront aberration data on a light flux with wavelength λ1 having passed through the first optical system at the image height portions provided by dividing the image height into 10 portions at the position of diaphragm STO, and (d) represents wavefront aberration data on a light flux with wavelength λ2 having passed through the second optical system. When a light flux with wavelength λ1 passes through an objective lens, a maximum object height is −0.61 mm, NA on the object side is 0.015 and a focal length is 1 mm. On the other hand, when a light flux with wavelength λ2 passes through an objective lens, a diaphragm diameter is 1.23 mm and NA on the object side is 0.6. In the present example, P2/Pt=−0.016 and |νp−νn|=1.50 hold.

In Table 5, (c) indicates that wavefront aberration of a light flux with wavelength λ1 having passed through the first optical system at each image height portion at the position of diaphragm STO is properly corrected. Further, (d) in Table 1 indicates that wavefront aberration of a light flux with wavelength λ2 having passed through the second optical system is properly corrected.

TABLE 5
(a) Lens data table

| | | d | d | | | | | |
|---|---|---|---|---|---|---|---|---|
| Surface | | (Optical | (Optical | | | | | |
| No. | r | system 1) | system 2) | n(λ1) | n(λ2) | nd | νd | Remarks |
| 0 | — | 0 | −30.562 | | | | | |
| STO | ∞ | 0.730 | 0.730 | | | | | Diaphragm |
| 2 | 0.88470 | 0.490 | 0.490 | 1.839654 | 1.800681 | 1.806105 | 40.7 | NBFD13_HOYA |
| 3 | 0.75376 | 0.240 | 0.240 | | | | | |
| 4 | −1.43242 | 0.170 | 0.170 | 1.621761 | 1.59138 | 1.59551 | 39.2 | EF8_HOYA |
| 5 | −1.55635 | 0.080 | 0.080 | | | | | |
| 6 | 0.48025 | 0.550 | 0.550 | 1.839654 | 1.800681 | 1.806105 | 40.7 | NBFD13_HOYA |
| 7 | 0.70686 | 0.120 | 0.120 | | | | | |
| 8 | ∞ | 0.300 | 0.300 | 1.506074 | 1.489154 | — | — | Hologram |
| | | | | | | | | recording |
| | | | | | | | | medium |
| 9 | ∞ | 0 | 0 | | | | | |

(b) Aspheric surface data

| | 2^{nd} surface | 3^{rd} surface | 6^{th} surface | 7^{th} surface |
|---|---|---|---|---|
| k | −1.18265E+00 | −3.80727E+00 | −2.90550E−01 | −4.20728E+00 |
| A4 | −9.55699E−02 | −2.23829E−01 | −2.50711E−01 | 5.34464E+00 |
| A6 | 6.06006E−03 | −6.60465E−01 | 4.69388E−01 | 1.05114E+01 |
| A8 | −4.97354E−02 | 1.38736E+00 | −5.07654E+00 | −3.81208E+02 |
| A10 | 1.36760E−01 | −7.94914E−01 | 2.78201E+01 | 7.72385E+02 |
| A12 | — | — | −9.65585E+01 | −5.20731E−02 |

(c) Wavefront aberration data of optical system 1 (λ1)

| Image height | Wavefront aberration |
|---|---|
| (mm) | (λrms) |
| 0.00 | 0.004 |
| 0.06 | 0.004 |
| 0.12 | 0.004 |
| 0.18 | 0.004 |
| 0.24 | 0.005 |
| 0.30 | 0.005 |
| 0.37 | 0.007 |
| 0.43 | 0.011 |
| 0.49 | 0.017 |
| 0.55 | 0.025 |
| 0.61 | 0.035 |

(d) Wavefront aberration data of optical system 2 (λ2)

| | Wavefront aberration |
|---|---|
| | (λrms) |
| Optical | 0.017 |
| system 2 | |

In Example 5, the 1^{st} surface, the 2^{nd} surface, the 5^{th} surface and the 6^{th} surface only are made to be an aspheric surface, which is apparent from aspheric surface data in Table 2 showing conic constant κ and aspheric surface coefficient A2i of each surface.

### Example 6

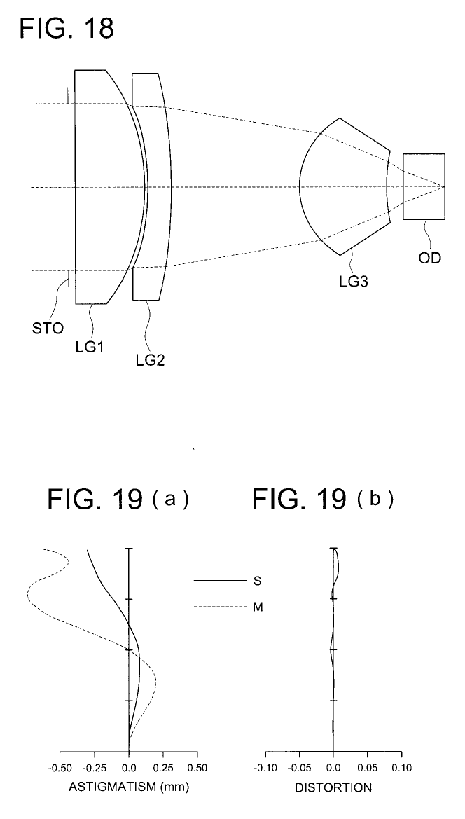

Each of FIG. 17 and FIG. 18 is a cross-sectional view relating to Example 6 of an objective lens capable of being used for an optical pickup apparatus shown in FIG. 1. FIG. 17 shows an optical path of a violet laser light (wavelength λ1) in the case of recording and/or reproducing of information, while, FIG. 18 shows an optical path of a red laser light (wavelength λ2) for focusing and tracking. FIG. 19(a) is a diagram showing a curvature of the field on a light-receiving element and FIG. 19(b) is a diagram showing distortion on a light-receiving element, both in the case of reproducing hologram in the present embodiment. In each of FIG. 17 and FIG. 18, an objective lens has therein positive first lens group LG1, negative second lens group LG2 and positive third lens group LG3 in this order from the light source side, and a light source side optical surface of the first lens group LG1 that is closest to the light source is convex toward the light source side.

In FIG. 17, a spatial light modulator is arranged at the position of diaphragm STO, or a relay lens is arranged so that an image of the spatial light modulator may be formed at this position. A diffraction angle of a light flux diffracted by a cell of the spatial light modulator is dependent on a size of the cell, and a diffraction angle was set to 0.86° in the present example. A light flux with wavelength λ1 entering from the spatial light modulator changes into a collimated light flux after being transmitted through an objective lens, and it records interference fringes formed through interference with reference light, on hologram recording medium OD.

On the other hand, as for a light flux with wavelength λ2 for tracking and focusing operations, its optical path is adjusted to a light flux with wavelength λ1 by a dichroic mirror, and then, the light flux is restricted by diaphragm STO, thus the light flux converged by the objective lens is transmitted through a hologram recording layer to be focused on a layer on which pits for servo are recorded.

In Table 6, (a) represents lens data, (b) represents aspheric surface data, (c) represents wavefront aberration data on a light flux with wavelength λ1 having passed through the first optical system at the image height portions provided by dividing the image height into 10 portions at the position of diaphragm STO, and (d) represents wavefront aberration data on a light flux with wavelength λ2 having passed through the second optical system. When a light flux with wavelength λ1 passes through an objective lens, a maximum object height is −0.61 mm, NA on the object side is 0.015 and a focal length is 1 mm. On the other hand, when a light flux with wavelength λ2 passes through an objective lens, a diaphragm diameter is 1.23 mm and NA on the object side is 0.6. In the present example, P2/Pt=−0.294 and |νp−νn|=35.90 hold.

In Table 6, (c) indicates that wavefront aberration of a light flux with wavelength λ1 having passed through the first optical system at each image height portion at the position of diaphragm STO is properly corrected. Further, (d) in Table 1 indicates that wavefront aberration of a light flux with wavelength λ2 having passed through the second optical system is properly corrected.

TABLE 6
(a) Lens data table

| | | d | d | | | | | |
|---|---|---|---|---|---|---|---|---|
| Surface | | (Optical | (Optical | | | | | |
| No. | r | system 1) | system 2) | n(λ1) | n(λ2) | nd | νd | Remarks |
| 0 | — | 0 | ∞ | | | | | |
| STO | ∞ | 0.050 | 0.050 | | | | | Diaphragm |
| 2 | −57.93937 | 0.490 | 0.490 | 1.778748 | 1.750974 | 1.755 | 52.3 | TAC6_HOYA |
| 3 | −1.37075 | 0.020 | 0.020 | | | | | |
| 4 | −1.66001 | 0.170 | 0.170 | 2.005887 | 1.911335 | 1.92286 | 20.9 | EFDS1_HOYA |
| 5 | −3.38572 | 0.930 | 0.930 | | | | | |
| 6 | 0.52515 | 0.630 | 0.630 | 1.604728 | 1.586417 | 1.58913 | 61.3 | MBACD5N_HOYA |
| 7 | 1.49024 | 0.120 | 0.120 | | | | | |
| 8 | ∞ | 0.300 | 0.300 | 1.506074 | 1.489154 | — | — | Hologram |
| | | | | | | | | recording |
| | | | | | | | | medium |
| 9 | ∞ | 0 | 0 | | | | | |

(b) Aspheric surface data

| | 3^{rd} surface | 6^{th} surface | 7^{th} surface |
|---|---|---|---|
| k | −3.39896E−01 | −8.83333E−01 | −5.49994E+00 |
| A4 | −1.28906E−01 | 2.50042E−01 | 7.39709E+00 |
| A6 | 3.31093E−01 | −1.56441E+00 | −6.38346E+02 |
| A8 | −1.81389E−01 | −1.82196E+01 | 1.67176E+04 |
| A10 | — | 2.83692E+02 | −1.32949E+05 |
| A12 | — | −5.54613E+02 | 8.37791E+02 |

(c) Wavefront aberration data of optical system 1 (λ1)

| Image height | Wavefront aberration |
|---|---|
| (mm) | (λrms) |
| 0.00 | 0.021 |
| 0.06 | 0.019 |
| 0.12 | 0.016 |
| 0.18 | 0.013 |
| 0.24 | 0.013 |
| 0.30 | 0.019 |
| 0.37 | 0.037 |
| 0.43 | 0.057 |
| 0.49 | 0.063 |
| 0.55 | 0.053 |
| 0.61 | 0.061 |

(d) Wavefront aberration data of optical system 2 (λ2)

| | Wavefront aberration |
|---|---|
| | (λrms) |
| Optical | 0.057 |
| system 2 | |

In Example 6, the 2^{nd} surface, the 5^{th} surface and the 6^{th} surface only are made to be an aspheric surface, which is apparent from aspheric surface data in Table 6 showing conic constant κ and aspheric surface coefficient A2i of each surface.

### Example 7

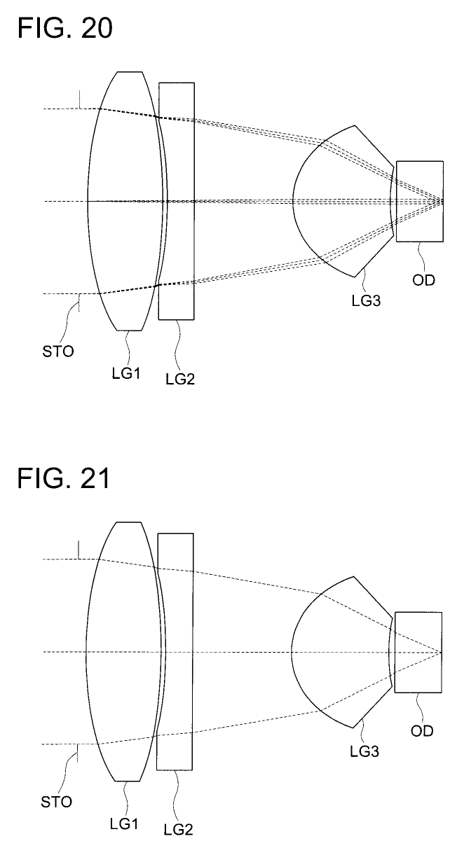

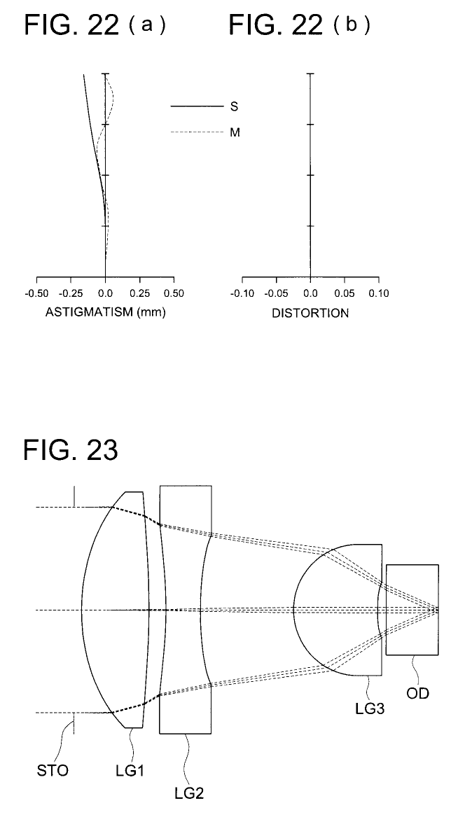

Each of FIG. 20 and FIG. 21 is a cross-sectional view relating to Example 7 of an objective lens capable of being used for an optical pickup apparatus shown in FIG. 1. FIG. 20 shows an optical path of a violet laser light (wavelength λ1) in the case of recording and/or reproducing of information, while, FIG. 21 shows an optical path of a red laser light (wavelength λ2) for focusing and tracking. FIG. 22(a) is a diagram showing a curvature of the field on a light-receiving element and FIG. 22(b) is a diagram showing distortion on a light-receiving element, both in the case of reproducing hologram in the present embodiment. In each of FIG. 20 and FIG. 21, an objective lens has therein positive first lens group LG1, negative second lens group LG2 and positive third lens group LG3 in this order from the light source side, and a light source side optical surface of the first lens group LG1 that is closest to the light source is convex toward the light source side.

In FIG. 20, a spatial light modulator is arranged at the position of diaphragm STO, or a relay lens is arranged so that an image of the spatial light modulator may be formed at this position. A diffraction angle of a light flux diffracted by a cell of the spatial light modulator is dependent on a size of the cell, and a diffraction angle was set to 0.86° in the present example. A light flux with wavelength λ1 entering from the spatial light modulator changes into a collimated light flux after being transmitted through an objective lens, and it records interference fringes formed through interference with reference light, on hologram recording medium OD.

On the other hand, as for a light flux with wavelength λ2 for tracking and focusing operations, its optical path is adjusted to a light flux with wavelength λ1 by a dichroic mirror, and then, the light flux is restricted by diaphragm STO, thus the light flux converged by the objective lens is transmitted through a hologram recording layer to be focused on a layer on which pits for servo are recorded.

In Table 7, (a) represents lens data, (b) represents aspheric surface data, (c) represents wavefront aberration data on a light flux with wavelength λ1 having passed through the first optical system at the image height portions provided by dividing the image height into 10 portions at the position of diaphragm STO, and (d) represents wavefront aberration data on a light flux with wavelength λ2 having passed through the second optical system. When a light flux with wavelength λ1 passes through an objective lens, a maximum object height is −0.61 mm, NA on the object side is 0.015 and a focal length is 1 mm. On the other hand, when a light flux with wavelength λ2 passes through an objective lens, a diaphragm diameter is 1.23 mm and NA on the object side is 0.6. In the present example, P2/Pt=−0.390 and |νp−νn|=35.90 hold.

In Table 7, (c) indicates that wavefront aberration of a light flux with wavelength λ1 having passed through the first optical system at each image height portion at the position of diaphragm STO is properly corrected. Further, (d) in Table 1 indicates that wavefront aberration of a light flux with wavelength λ2 having passed through the second optical system is properly corrected.

TABLE 7
(a) Lens data table

| | | d | d | | | | | |
|---|---|---|---|---|---|---|---|---|
| | | (Optical | (Optical | | | | | |
| Surface | | system | system | | | | | |
| No. | r | 1) | 2) | n (λ1) | n (λ2) | nd | νd | Remarks |
| 0 | — | 0 | ∞ | | | | | |
| STO | ∞ | 0.050 | 0.050 | | | | | Diaphragm |
| 2 | 2.00236 | 0.490 | 0.490 | 1.778748 | 1.750974 | 1.755 | 52.3 | TAC6_HOYA |
| 3 | −2.69500 | 0.030 | 0.030 | | | | | |
| 4 | −2.54008 | 0.170 | 0.170 | 2.005887 | 1.911335 | 1.92286 | 20.9 | EFDS1_HOYA |
| 5 | −173.08814 | 0.640 | 0.640 | | | | | |
| 6 | 0.52750 | 0.630 | 0.630 | 1.604728 | 1.586417 | 1.58913 | 61.3 | MBACD5N_HOYA |
| 7 | 2.69259 | 0.040 | 0.040 | | | | | |
| 8 | ∞ | 0.300 | 0.300 | 1.506074 | 1.489154 | — | — | Hologram |
| | | | | | | | | recording |
| | | | | | | | | medium |
| 9 | ∞ | 0 | 0 | | | | | |

(b) Aspheric surface data

| | 3^{rd} surface | 6^{th} surface | 7^{th} surface |
|---|---|---|---|
| k | −1.00767E+01 | −4.56121E−01 | 0.00000E+00 |
| A4 | −3.84158E−02 | 4.51021E−01 | 7.41609E+00 |
| A6 | 6.26903E−02 | 4.25291E+00 | −2.32783E+02 |
| A8 | −9.00208E−02 | −2.60013E+01 | 1.43166E+04 |
| A10 | — | 1.96373E+02 | −2.11518E+05 |
| A12 | — | −2.48125E+02 | 8.37791E+02 |

(c) Wavefront aberration data of optical system 1 (λ1)

| Image height | Wavefront aberration |
|---|---|
| (mm) | (λrms) |
| 0.00 | 0.000 |
| 0.06 | 0.001 |
| 0.12 | 0.001 |
| 0.18 | 0.002 |
| 0.24 | 0.001 |
| 0.30 | 0.003 |
| 0.37 | 0.005 |
| 0.43 | 0.006 |
| 0.49 | 0.009 |
| 0.55 | 0.010 |
| 0.61 | 0.010 |

(d) Wavefront aberration data of optical system 2 (λ2)

| | Wavefront aberration |
|---|---|
| | (λrms) |
| Optical | 0.003 |
| system 2 | |

In Example 7, the 2^{nd} surface, the 5^{th} surface and the 6^{th} surface only are made to be an aspheric surface, which is apparent from aspheric surface data in Table 7 showing conic constant κ and aspheric surface coefficient A2i of each surface.

### Example 8

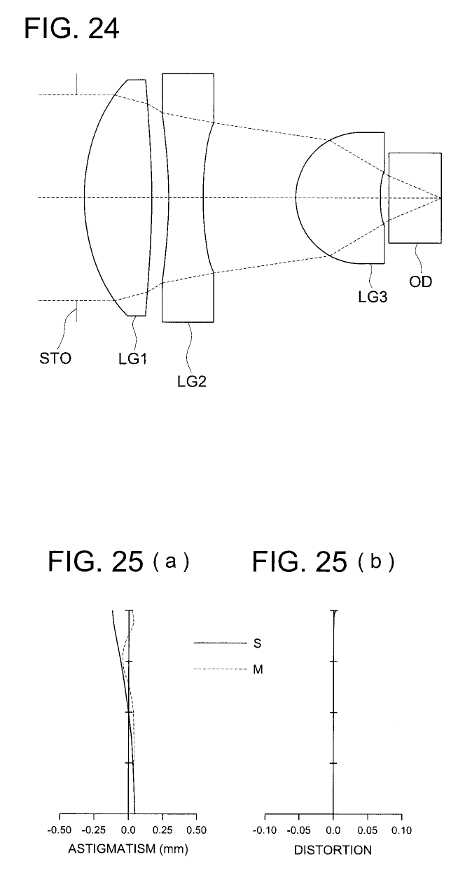

Each of FIG. 23 and FIG. 24 is a cross-sectional view relating to Example 8 of an objective lens capable of being used for an optical pickup apparatus shown in FIG. 1. FIG. 23 shows an optical path of a violet laser light (wavelength λ1) in the case of recording and/or reproducing of information, while, FIG. 24 shows an optical path of a red laser light (wavelength λ2) for focusing and tracking. FIG. 25(a) is a diagram showing a curvature of the field on a light-receiving element and FIG. 25(b) is a diagram showing distortion on a light-receiving element, both in the case of reproducing hologram in the present embodiment. In each of FIG. 23 and FIG. 24, an objective lens has therein positive first lens group LG1, negative second lens group LG2 and positive third lens group LG3 in this order from the light source side, and a light source side optical surface of the first lens group LG1 that is closest to the light source is convex toward the light source side.

In FIG. 23, a spatial light modulator is arranged at the position of diaphragm STO, or a relay lens is arranged so that an image of the spatial light modulator may be formed at this position. A diffraction angle of a light flux diffracted by a cell of the spatial light modulator is dependent on a size of the cell, and a diffraction angle was set to 0.86° in the present example. A light flux with wavelength λ1 entering from the spatial light modulator changes into a collimated light flux after being transmitted through an objective lens, and it records interference fringes formed through interference with reference light, on hologram recording medium OD.

On the other hand, as for a light flux with wavelength λ2 for tracking and focusing operations, its optical path is adjusted to a light flux with wavelength λ1 by a dichroic mirror, and then, the light flux is restricted by diaphragm STO, thus the light flux converged by the objective lens is transmitted through a hologram recording layer to be focused on a layer on which pits for servo are recorded.

In Table 8, (a) represents lens data, (b) represents aspheric surface data, (c) represents wavefront aberration data on a light flux with wavelength λ1 having passed through the first optical system at the image height portions provided by dividing the image height into 10 portions at the position of diaphragm STO, and (d) represents wavefront aberration data on a light flux with wavelength λ2 having passed through the second optical system. When a light flux with wavelength λ1 passes through an objective lens, a maximum object height is −0.61 mm, NA on the object side is 0.015 and a focal length is 1 mm. On the other hand, when a light flux with wavelength λ2 passes through an objective lens, a diaphragm diameter is 1.23 mm and NA on the object side is 0.6. In the present example, P2/Pt=−0.807 and |νp−νn|=31.65 hold.

In Table 8, (c) indicates that wavefront aberration of a light flux with wavelength λ1 having passed through the first optical system at each image height portion at the position of diaphragm STO is properly corrected. Further, (d) in Table 1 indicates that wavefront aberration of a light flux with wavelength λ2 having passed through the second optical system is properly corrected.

TABLE 8
(a) Lens data table

| | | d | d | | | | | |
|---|---|---|---|---|---|---|---|---|
| | | (Optical | (Optical | | | | | |
| Surface | | system | system | | | | | |
| No. | r | 1) | 2) | n (λ1) | n (λ2) | nd | νd | Remarks |
| 0 | — | 0 | ∞ | | | | | |
| STO | ∞ | 0.050 | 0.050 | | | | | Diaphragm |
| 2 | 1.12847 | 0.380 | 0.380 | 1.798236 | 1.768168 | 1.7725 | 49.6 | TAF1_HOYA |
| 3 | −8.16358 | 0.100 | 0.100 | | | | | |
| 4 | −3.67731 | 0.200 | 0.200 | 1.911736 | 1.837276 | 1.846663 | 23.8 | FDS90_HOYA |
| 5 | 1.67324 | 0.540 | 0.540 | | | | | |
| 6 | 0.39241 | 0.490 | 0.490 | 1.604728 | 1.586417 | 1.58913 | 61.3 | MBACD5N_HOYA |
| 7 | 1.17742 | 0.050 | 0.050 | | | | | |
| 8 | ∞ | 0.300 | 0.300 | 1.506074 | 1.489154 | — | — | Hologram |
| | | | | | | | | recording |
| | | | | | | | | medium |
| 9 | ∞ | 0 | 0 | | | | | |

(b) Aspheric surface data

| | 6^{th} surface | 7^{th} surface |
|---|---|---|
| k | −6.63983E−05 | −2.32992E+00 |
| A4 | −2.02841E−01 | 7.98977E+00 |
| A6 | −6.13845E−01 | 2.37345E+02 |
| A8 | 1.63044E+01 | −1.12133E+04 |
| A10 | −2.96522E+02 | 3.60184E+05 |
| A12 | 1.58651E+03 | −5.19566E−02 |

(c) Wavefront aberration data of optical system 1 (λ1)

| Image height | Wavefront aberration |
|---|---|
| (mm) | (λrms) |
| 0.00 | 0.004 |
| 0.06 | 0.004 |
| 0.12 | 0.003 |
| 0.18 | 0.003 |
| 0.24 | 0.003 |
| 0.30 | 0.002 |
| 0.37 | 0.002 |
| 0.43 | 0.003 |
| 0.49 | 0.005 |
| 0.55 | 0.007 |
| 0.61 | 0.008 |

(d) Wavefront aberration data of optical system 2 (λ2)

| | Wavefront aberration |
|---|---|
| | (λrms) |
| Optical | 0.004 |
| system 2 | |

In Example 8, the 5^{th} surface and the 6^{th} surface only are made to be an aspheric surface, which is apparent from aspheric surface data in Table 8 showing conic constant κ and aspheric surface coefficient A2i of each surface.

### Example 9

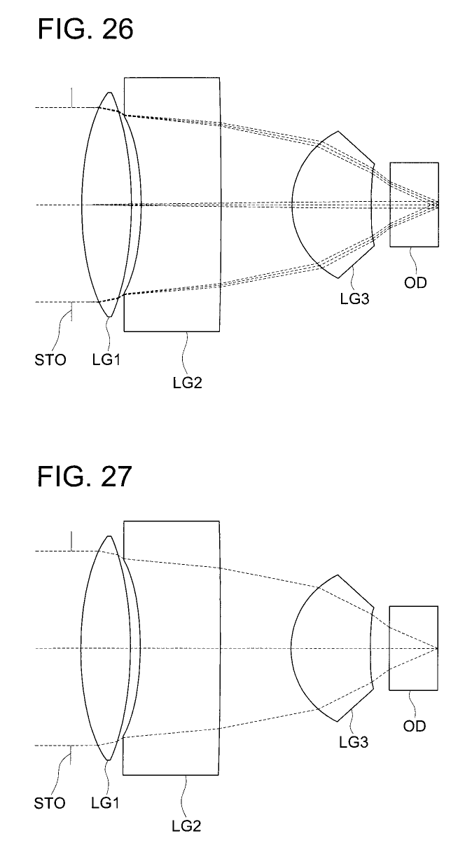

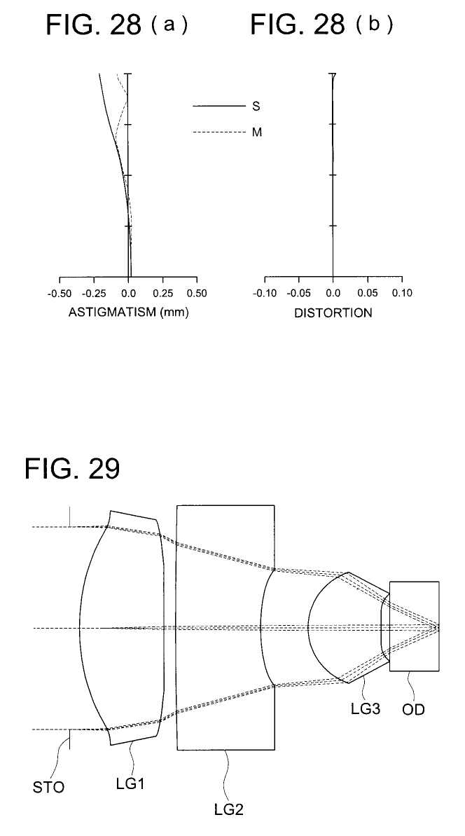

Each of FIG. 26 and FIG. 27 is a cross-sectional view relating to Example 9 of an objective lens capable of being used for an optical pickup apparatus shown in FIG. 1. FIG. 26 shows an optical path of a violet laser light (wavelength λ1) in the case of recording and/or reproducing of information, while, FIG. 27 shows an optical path of a red laser light (wavelength λ2) for focusing and tracking. FIG. 28(a) is a diagram showing a curvature of the field on a light-receiving element and FIG. 28(b) is a diagram showing distortion on a light-receiving element, both in the case of reproducing hologram in the present embodiment. In each of FIG. 26 and FIG. 27, an objective lens has therein positive first lens group LG1, negative second lens group LG2 and positive third lens group LG3 in this order from the light source side, and a light source side optical surface of the first lens group LG1 that is closest to the light source is convex toward the light source side.

In FIG. 26, a spatial light modulator is arranged at the position of diaphragm STO, or a relay lens is arranged so that an image of the spatial light modulator may be formed at this position. A diffraction angle of a light flux diffracted by a cell of the spatial light modulator is dependent on a size of the cell, and a diffraction angle was set to 0.86° in the present example. A light flux with wavelength λ1 entering from the spatial light modulator changes into a collimated light flux after being transmitted through an objective lens, and it records interference fringes formed through interference with reference light, on hologram recording medium OD.

On the other hand, as for a light flux with wavelength λ2 for tracking and focusing operations, its optical path is adjusted to a light flux with wavelength λ1 by a dichroic mirror, and then, the light flux is restricted by diaphragm STO, thus the light flux converged by the objective lens is transmitted through a hologram recording layer to be focused on a layer on which pits for servo are recorded.

In Table 9, (a) represents lens data, (b) represents aspheric surface data, (c) represents wavefront aberration data on a light flux with wavelength λ1 having passed through the first optical system at the image height portions provided by dividing the image height into 10 portions at the position of diaphragm STO, and (d) represents wavefront aberration data on a light flux with wavelength λ2 having passed through the second optical system. When a light flux with wavelength λ1 passes through an objective lens, a maximum object height is −0.61 mm, NA on the object side is 0.015 and a focal length is 1 mm. On the other hand, when a light flux with wavelength λ2 passes through an objective lens, a diaphragm diameter is 1.23 mm and NA on the object side is 0.6. In the present example, P2/Pt=−0.547 and |νp−νn|=31.65 hold.

In Table 9, (c) indicates that wavefront aberration of a light flux with wavelength λ1 having passed through the first optical system at each image height portion at the position of diaphragm STO is properly corrected. Further, (d) in Table 1 indicates that wavefront aberration of a light flux with wavelength λ2 having passed through the second optical system is properly corrected.

TABLE 9
(a) Lens data table

| | | d | d | | | | | |
|---|---|---|---|---|---|---|---|---|
| | | (Optical | (Optical | | | | | |
| Surface | | system | system | | | | | |
| No. | r | 1) | 2) | n (λ1) | n (λ2) | nd | νd | Remarks |
| 0 | — | 0 | ∞ | | | | | |
| STO | ∞ | 0.050 | 0.050 | | | | | Diaphragm |
| 2 | 1.61694 | 0.310 | 0.310 | 1.798236 | 1.768168 | 1.7725 | 49.6 | TAF1_HOYA |
| 3 | −2.09033 | 0.060 | 0.060 | | | | | |
| 4 | −1.58394 | 0.490 | 0.490 | 1.911736 | 1.837276 | 1.846663 | 23.8 | FDS90_HOYA |
| 5 | −36.10689 | 0.440 | 0.440 | | | | | |
| 6 | 0.58358 | 0.490 | 0.490 | 1.604728 | 1.586417 | 1.58913 | 61.3 | MBACD5N_HOYA |
| 7 | 74.44448 | 0.110 | 0.110 | | | | | |
| 8 | ∞ | 0.300 | 0.300 | 1.506074 | 1.489154 | — | — | Hologram |
| | | | | | | | | recording |
| | | | | | | | | medium |
| 9 | ∞ | 0 | 0 | | | | | |

(b) Aspheric surface data

| | 6^{th} surface | 7^{th} surface |
|---|---|---|
| k | −1.33174E+00 | 0.00000E+00 |
| A4 | 1.07616E+00 | 3.22108E+00 |
| A6 | 1.60800E+00 | −5.27068E+01 |
| A8 | 1.15520E+01 | 1.61034E+03 |
| A10 | −2.35856E+01 | −8.40862E+03 |
| A12 | 4.57945E+02 | −3.97587E+02 |

(c) Wavefront aberration data of optical system 1 (λ1)

| Image height | Wavefront aberration |
|---|---|
| (mm) | (λrms) |
| 0.00 | 0.002 |
| 0.06 | 0.002 |
| 0.12 | 0.002 |
| 0.18 | 0.002 |
| 0.24 | 0.001 |
| 0.30 | 0.002 |
| 0.37 | 0.005 |
| 0.43 | 0.007 |
| 0.49 | 0.009 |
| 0.55 | 0.011 |
| 0.61 | 0.013 |

(d) Wavefront aberration data of optical system 2 (λ2)

| | Wavefront aberration |
|---|---|
| | (λrms) |
| Optical | 0.010 |
| system 2 | |

In Example 9, the 5^{th} surface and the 6^{th} surface only are made to be an aspheric surface, which is apparent from aspheric surface data in Table 9 showing conic constant κ and aspheric surface coefficient A2i of each surface.

### Example 10

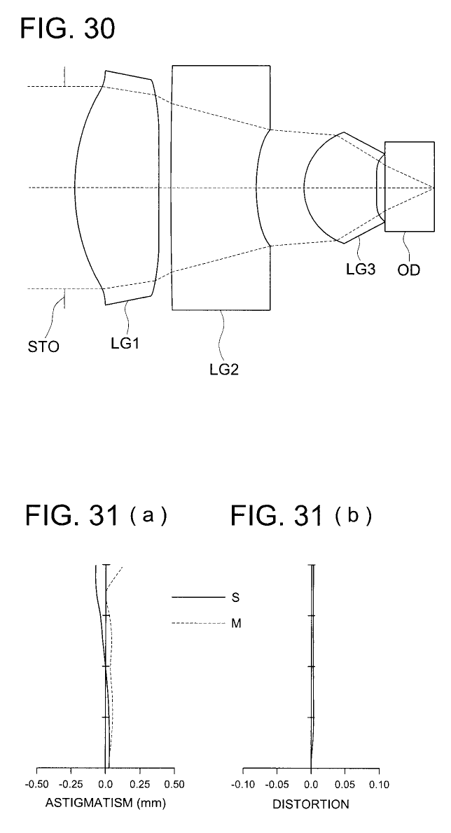

Each of FIG. 29 and FIG. 30 is a cross-sectional view relating to Example 10 of an objective lens capable of being used for an optical pickup apparatus shown in FIG. 1. FIG. 29 shows an optical path of a violet laser light (wavelength λ1) in the case of recording and/or reproducing of information, while, FIG. 30 shows an optical path of a red laser light (wavelength λ2) for focusing and tracking. FIG. 31(a) is a diagram showing a curvature of the field on a light-receiving element and FIG. 31(b) is a diagram showing distortion on a light-receiving element, both in the case of reproducing hologram in the present embodiment. In each of FIG. 29 and FIG. 30, an objective lens has therein positive first lens group LG1, negative second lens group LG2 and positive third lens group LG3 in this order from the light source side, and a light source side optical surface of the first lens group LG1 that is closest to the light source is convex toward the light source side.

In FIG. 29, a spatial light modulator is arranged at the position of diaphragm STO, or a relay lens is arranged so that an image of the spatial light modulator may be formed at this position. A diffraction angle of a light flux diffracted by a cell of the spatial light modulator is dependent on a size of the cell, and a diffraction angle was set to 0.86° in the present example. A light flux with wavelength λ1 entering from the spatial light modulator changes into a collimated light flux after being transmitted through an objective lens, and it records interference fringes formed through interference with reference light, on hologram recording medium OD.

On the other hand, as for a light flux with wavelength λ2 for tracking and focusing operations, its optical path is adjusted to a light flux with wavelength λ1 by a dichroic mirror, and then, the light flux is restricted by diaphragm STO, thus the light flux converged by the objective lens is transmitted through a hologram recording layer to be focused on a layer on which pits for servo are recorded.

In Table 10, (a) represents lens data, (b) represents aspheric surface data, (c) represents wavefront aberration data on a light flux with wavelength λ1 having passed through the first optical system at the image height portions provided by dividing the image height into 10 portions at the position of diaphragm STO, and (d) represents wavefront aberration data on a light flux with wavelength λ2 having passed through the second optical system. When a light flux with wavelength λ1 passes through an objective lens, a maximum object height is −0.61 mm, NA on the object side is 0.015 and a focal length is 1 mm. On the other hand, when a light flux with wavelength λ2 passes through an objective lens, a diaphragm diameter is 1.23 mm and NA on the object side is 0.6. In the present example, P2/Pt=−1.179 and |νp−νn|=31.15 hold.

In Table 10, (c) indicates that wavefront aberration of a light flux with wavelength λ1 having passed through the first optical system at each image height portion at the position of diaphragm STO is properly corrected. Further, (d) in Table 1 indicates that wavefront aberration of a light flux with wavelength λ2 having passed through the second optical system is properly corrected.

TABLE 10
(a) Lens data table

| | | d | d | | | | | |
|---|---|---|---|---|---|---|---|---|
| | | (Optical | (Optical | | | | | |
| Surface | | system | system | | | | | |
| No. | r | 1) | 2) | n (λ1) | n (λ2) | nd | νd | Remarks |
| 0 | — | 0 | ∞ | | | | | |
| STO | ∞ | 0.050 | 0.050 | | | | | Diaphragm |
| 2 | 1.10451 | 0.490 | 0.490 | 1.798236 | 1.768168 | 1.7725 | 49.6 | TAF1_HOYA |
| 3 | −274.11770 | 0.070 | 0.070 | | | | | |
| 4 | 18.75257 | 0.490 | 0.490 | 1.911736 | 1.837276 | 1.846663 | 23.8 | FDS90_HOYA |
| 5 | 0.73340 | 0.280 | 0.280 | | | | | |
| 6 | 0.33123 | 0.430 | 0.430 | 1.637136 | 1.617519 | 1.620409 | 60.3 | BACD16_HOYA |
| 7 | 1.52650 | 0.050 | 0.050 | | | | | |
| 8 | ∞ | 0.300 | 0.300 | 1.506074 | 1.489154 | — | — | Hologram |
| | | | | | | | | recording |
| | | | | | | | | medium |
| 9 | ∞ | 0 | 0 | | | | | |

(b) Aspheric surface data

| | 2^{nd} surface | 3^{rd} surface | 6^{th} surface | 7^{th} surface |
|---|---|---|---|---|
| k | −1.59240E−01 | 0.00000E+00 | −1.08514E−01 | −5.02678E+00 |
| A4 | −4.47970E−03 | −5.07788E−02 | −1.09211E+00 | 9.37834E+00 |
| A6 | −1.98744E−01 | −2.95125E−02 | 2.83624E+01 | 4.04307E+02 |
| A8 | 2.77686E−01 | −9.41186E−01 | −4.85455E+02 | −1.47862E+04 |
| A10 | −4.56489E−01 | −2.89448E+00 | 3.81554E+03 | 4.10242E+05 |
| A12 | −2.82341E+00 | 6.09411E+00 | −1.18024E+04 | −5.15625E−02 |

(c) Wavefront aberration data of optical system 1 (λ1)

| Image height | Wavefront aberration |
|---|---|
| (mm) | (λrms) |
| 0.00 | 0.002 |
| 0.06 | 0.002 |
| 0.12 | 0.003 |
| 0.18 | 0.003 |
| 0.24 | 0.003 |
| 0.30 | 0.002 |
| 0.37 | 0.003 |
| 0.43 | 0.004 |
| 0.49 | 0.004 |
| 0.55 | 0.005 |
| 0.61 | 0.008 |

(d) Wavefront aberration data of optical system 2 (λ2)

| | Wavefront aberration |
|---|---|
| | (λrms) |
| Optical | 0.004 |
| system 2 | |

In Example 10, the 1^{st} surface, the 2^{nd} surface, the 5^{th} surface and the 6^{th} surface only are made to be an aspheric surface, which is apparent from aspheric surface data in Table 10 showing conic constant κ and aspheric surface coefficient A2i of each surface.

### Example 11

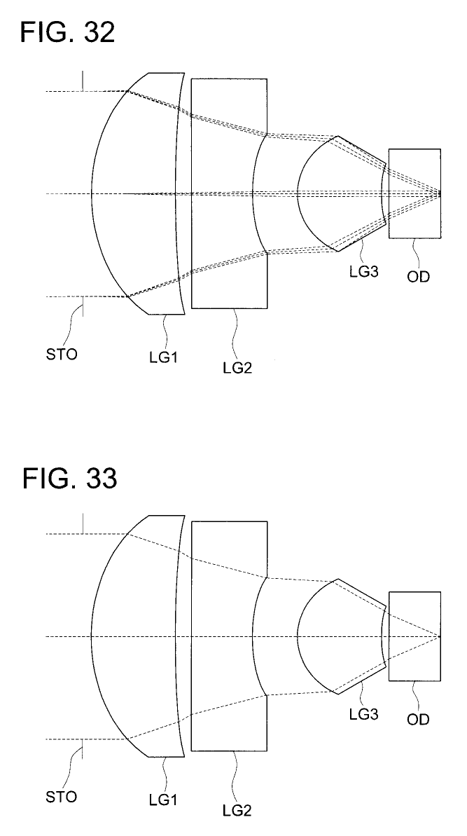

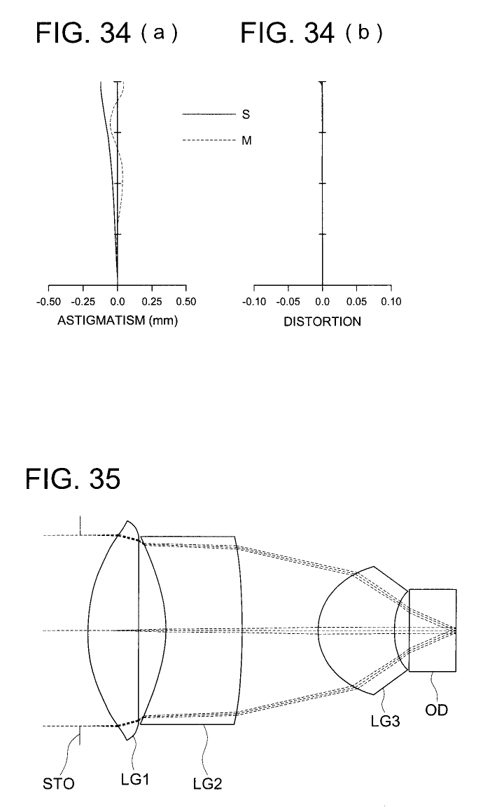

Each of FIG. 32 and FIG. 33 is a cross-sectional view relating to Example 11 of an objective lens capable of being used for an optical pickup apparatus shown in FIG. 1. FIG. 32 shows an optical path of a violet laser light (wavelength λ1) in the case of recording and/or reproducing of information, while, FIG. 33 shows an optical path of a red laser light (wavelength λ2) for focusing and tracking. FIG. 34(a) is a diagram showing a curvature of the field on a light-receiving element and FIG. 34(b) is a diagram showing distortion on a light-receiving element, both in the case of reproducing hologram in the present embodiment. In each of FIG. 32 and FIG. 33, an objective lens has therein positive first lens group LG1, negative second lens group LG2 and positive third lens group LG3 in this order from the light source side, and a light source side optical surface of the first lens group LG1 that is closest to the light source is convex toward the light source side.

In FIG. 32, a spatial light modulator is arranged at the position of diaphragm STO, or a relay lens is arranged so that an image of the spatial light modulator may be formed at this position. A diffraction angle of a light flux diffracted by a cell of the spatial light modulator is dependent on a size of the cell, and a diffraction angle was set to 0.86° in the present example. A light flux with wavelength λ1 entering from the spatial light modulator changes into a collimated light flux after being transmitted through an objective lens, and it records interference fringes formed through interference with reference light, on hologram recording medium OD.

On the other hand, as for a light flux with wavelength λ2 for tracking and focusing operations, its optical path is adjusted to a light flux with wavelength λ1 by a dichroic mirror, and then, the light flux is restricted by diaphragm STO, thus the light flux converged by the objective lens is transmitted through a hologram recording layer to be focused on a layer on which pits for servo are recorded.

In Table 11, (a) represents lens data, (b) represents aspheric surface data, (c) represents wavefront aberration data on a light flux with wavelength λ1 having passed through the first optical system at the image height portions provided by dividing the image height into 10 portions at the position of diaphragm STO, and (d) represents wavefront aberration data on a light flux with wavelength λ2 having passed through the second optical system. When a light flux with wavelength λ1 passes through an objective lens, a maximum object height is −0.61 mm, NA on the object side is 0.015 and a focal length is 1 mm. On the other hand, when a light flux with wavelength λ2 passes through an objective lens, a diaphragm diameter is 1.23 mm and NA on the object side is 0.6. In the present example, P2/Pt=−1.225 and |νp−νn|=31.65 hold.

In Table 11, (c) indicates that wavefront aberration of a light flux with wavelength λ1 having passed through the first optical system at each image height portion at the position of diaphragm STO is properly corrected. Further, (d) in Table 1 indicates that wavefront aberration of a light flux with wavelength λ2 having passed through the second optical system is properly corrected.

TABLE 11
(a) Lens data table

| | | d | d | | | | | |
|---|---|---|---|---|---|---|---|---|
| | | (Optical | (Optical | | | | | |
| Surface | | system | system | | | | | |
| No. | r | 1) | 2) | n (λ1) | n (λ2) | nd | νd | Remarks |
| 0 | — | 0 | ∞ | | | | | |
| STO | ∞ | 0.050 | 0.050 | | | | | Diaphragm |
| 2 | 0.93917 | 0.490 | 0.490 | 1.798236 | 1.768168 | 1.7725 | 49.6 | TAF1_HOYA |
| 3 | 4.53840 | 0.100 | 0.100 | | | | | |
| 4 | −711.17370 | 0.350 | 0.350 | 1.911736 | 1.837276 | 1.846663 | 23.8 | FDS90_HOYA |
| 5 | 0.74540 | 0.270 | 0.270 | | | | | |
| 6 | 0.32841 | 0.490 | 0.490 | 1.604728 | 1.586417 | 1.58913 | 61.3 | MBACD5N_HOYA |
| 7 | 2.70676 | 0.040 | 0.040 | | | | | |
| 8 | ∞ | 0.300 | 0.300 | 1.506074 | 1.489154 | — | — | Hologram |
| | | | | | | | | recording |
| | | | | | | | | medium |
| 9 | ∞ | 0 | 0 | | | | | |

(b) Aspheric surface data

| | 6^{th} surface | 7^{th} surface |
|---|---|---|
| k | −2.13230E−01 | −7.94508E−01 |
| A4 | −6.07718E−01 | 1.08495E+01 |
| A6 | 1.77125E+00 | 3.24830E+02 |
| A8 | −3.30466E+01 | −1.80562E+04 |
| A10 | −1.34570E+02 | 5.30052E+05 |
| A12 | 1.58651E+03 | −5.19566E−02 |

(c) Wavefront aberration data of optical system 1 (λ1)

| Image height | Wavefront aberration |
|---|---|
| (mm) | (λrms) |
| 0.00 | 0.000 |
| 0.06 | 0.000 |
| 0.12 | 0.001 |
| 0.18 | 0.001 |
| 0.24 | 0.003 |
| 0.30 | 0.004 |
| 0.37 | 0.004 |
| 0.43 | 0.004 |
| 0.49 | 0.005 |
| 0.55 | 0.007 |
| 0.61 | 0.008 |

(d) Wavefront aberration data of optical system 2 (λ2)

| | Wavefront aberration |
|---|---|
| | (λrms) |
| Optical | 0.002 |
| system 2 | |

In Example 11, the 5^{th} surface and the 6^{th} surface only are made to be an aspheric surface, which is apparent from aspheric surface data in Table 11 showing conic constant κ and aspheric surface coefficient A2i of each surface.

### Example 12

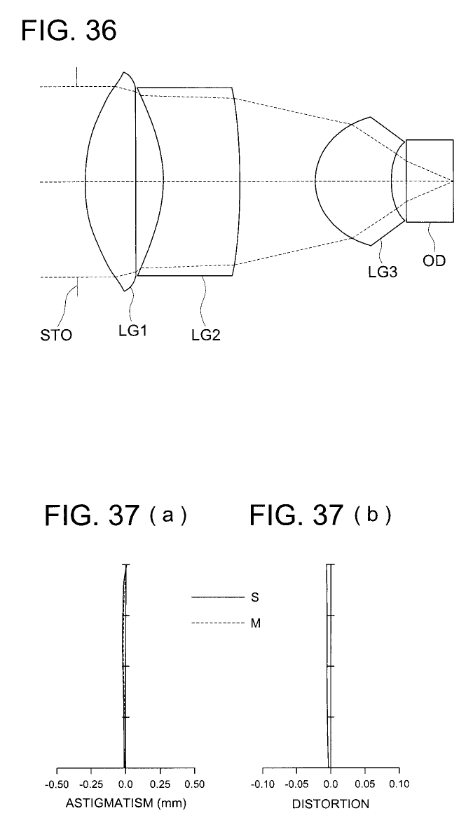

Each of FIG. 35 and FIG. 36 is a cross-sectional view relating to Example 12 of an objective lens capable of being used for an optical pickup apparatus shown in FIG. 1. FIG. 35 shows an optical path of a violet laser light (wavelength λ1) in the case of recording and/or reproducing of information, while, FIG. 36 shows an optical path of a red laser light (wavelength λ2) for focusing and tracking. FIG. 37(a) is a diagram showing a curvature of the field on a light-receiving element and FIG. 37(b) is a diagram showing distortion on a light-receiving element, both in the case of reproducing hologram in the present embodiment. In each of FIG. 35 and FIG. 36, an objective lens has therein positive first lens group LG1, negative second lens group LG2 and positive third lens group LG3 in this order from the light source side, and a light source side optical surface of the first lens group LG1 that is closest to the light source is convex toward the light source side.

In FIG. 35, a spatial light modulator is arranged at the position of diaphragm STO, or a relay lens is arranged so that an image of the spatial light modulator may be formed at this position. A diffraction angle of a light flux diffracted by a cell of the spatial light modulator is dependent on a size of the cell, and a diffraction angle was set to 0.86° in the present example. A light flux with wavelength λ1 entering from the spatial light modulator changes into a collimated light flux after being transmitted through an objective lens, and it records interference fringes formed through interference with reference light, on hologram recording medium OD.

On the other hand, as for a light flux with wavelength λ2 for tracking and focusing operations, its optical path is adjusted to a light flux with wavelength λ1 by a dichroic mirror, and then, the light flux is restricted by diaphragm STO, thus the light flux converged by the objective lens is transmitted through a hologram recording layer to be focused on a layer on which pits for servo are recorded.

In Table 12, (a) represents lens data, (b) represents aspheric surface data, (c) represents wavefront aberration data on a light flux with wavelength λ1 having passed through the first optical system at the image height portions provided by dividing the image height into 10 portions at the position of diaphragm STO, and (d) represents wavefront aberration data on a light flux with wavelength λ2 having passed through the second optical system. When a light flux with wavelength λ1 passes through an objective lens, a maximum object height is −0.61 mm, NA on the object side is 0.015 and a focal length is 1 mm. On the other hand, when a light flux with wavelength λ2 passes through an objective lens, a diaphragm diameter is 1.23 mm and NA on the object side is 0.6. In the present example, P2/Pt=−0.923 and |νp−νn|=31.65 hold.

In Table 12, (c) indicates that wavefront aberration of a light flux with wavelength λ1 having passed through the first optical system at each image height portion at the position of diaphragm STO is properly corrected. Further, (d) in Table 1 indicates that wavefront aberration of a light flux with wavelength λ2 having passed through the second optical system is properly corrected.

TABLE 12
(a) Lens data table

| | | d | d | | | | | |
|---|---|---|---|---|---|---|---|---|
| | | (Optical | (Optical | | | | | |
| Surface | | system | system | | | | | |
| No. | r | 1) | 2) | n (λ1) | n (λ2) | nd | νd | Remarks |
| 0 | — | 0 | ∞ | | | | | |
| STO | ∞ | 0.050 | 0.050 | | | | | Diaphragm |
| 2 | 1.04522 | 0.320 | 0.320 | 1.798236 | 1.768168 | 1.7725 | 49.6 | TAF1_HOYA |
| 3 | 37.93415 | 0.170 | 0.170 | | | | | |
| 4 | −0.97897 | 0.490 | 0.490 | 1.911736 | 1.837276 | 1.846663 | 23.8 | FDS90_HOYA |
| 5 | −128.90983 | 0.480 | 0.480 | | | | | |
| 6 | 0.33018 | 0.490 | 0.490 | 1.604728 | 1.586417 | 1.58913 | 61.3 | MBACD5N_HOYA |
| 7 | 0.52186 | 0.090 | 0.090 | | | | | |
| 8 | ∞ | 0.300 | 0.300 | 1.506074 | 1.489154 | — | — | Hologram |
| | | | | | | | | recording |
| | | | | | | | | medium |
| 9 | ∞ | 0 | 0 | | | | | |

(b) Aspheric surface data

| | 2^{nd} surface | 3^{rd} surface | 4^{th} surface | 5^{th} surface | 6^{th} surface | 7^{th} surface |
|---|---|---|---|---|---|---|
| k | −1.40228E−01 | −1.10000E+01 | −9.37035E−01 | −1.13086E+17 | −7.25454E−01 | −2.58289E+00 |
| A4 | −1.19126E−02 | −1.05690E−01 | 1.22379E−01 | −7.29089E−01 | 3.58600E−01 | 1.03994E+01 |
| A6 | 1.36338E−03 | 1.01088E−01 | 4.75542E−01 | 8.32579E−01 | 1.53476E+00 | −2.66547E+02 |
| A8 | −6.59600E−01 | 6.12301E−01 | 1.16996E+00 | 5.49483E+00 | 1.24790E+01 | 8.95196E+03 |
| A10 | 4.12401E+00 | 3.57715E+00 | −7.37700E+00 | −2.19323E+01 | −4.60404E+00 | −9.12744E+04 |
| A12 | −6.15762E+00 | −1.47251E+01 | 4.16053E+00 | 2.28369E+01 | 1.32245E+03 | 4.42584E+01 |

(c) Wavefront aberration data of optical system 1 (λ1)

| Image height | Wavefront aberration |
|---|---|
| (mm) | (λrms) |
| 0.00 | 0.001 |
| 0.06 | 0.000 |
| 0.12 | 0.001 |
| 0.18 | 0.001 |
| 0.24 | 0.001 |
| 0.30 | 0.001 |
| 0.37 | 0.001 |
| 0.43 | 0.001 |
| 0.49 | 0.001 |
| 0.55 | 0.001 |
| 0.61 | 0.001 |

(d) Wavefront aberration data of optical system 2 (λ2)

| | Wavefront aberration |
|---|---|
| | (λrms) |
| Optical | 0.001 |
| system 2 | |

In Example 12, all of the 1^{st}-the 6^{th} surfaces are made to be an aspheric surface, which is apparent from aspheric surface data in Table 12 showing conic constant κ and aspheric surface coefficient A2i of each surface.

### Example 13

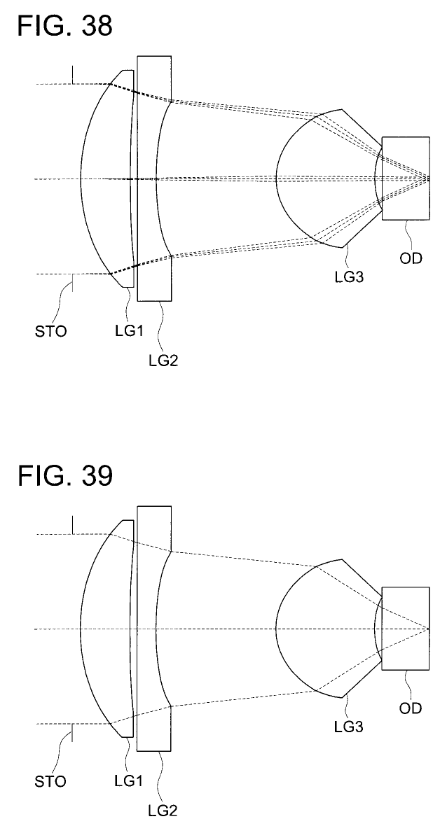

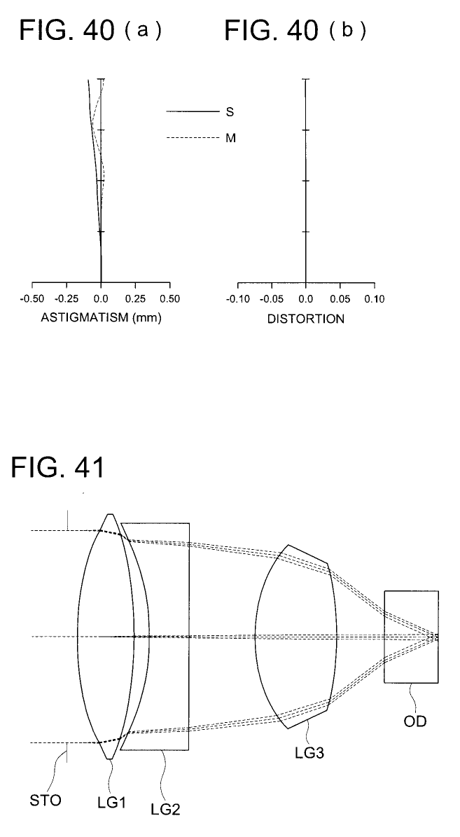

Each of FIG. 38 and FIG. 39 is a cross-sectional view relating to Example 13 of an objective lens capable of being used for an optical pickup apparatus shown in FIG. 1. FIG. 38 shows an optical path of a violet laser light (wavelength λ1) in the case of recording and/or reproducing of information, while, FIG. 39 shows an optical path of a red laser light (wavelength λ2) for focusing and tracking. FIG. 40(a) is a diagram showing a curvature of the field on a light-receiving element and FIG. 40(b) is a diagram showing distortion on a light-receiving element, both in the case of reproducing hologram in the present embodiment. In each of FIG. 38 and FIG. 39, an objective lens has therein positive first lens group LG1, negative second lens group LG2 and positive third lens group LG3 in this order from the light source side, and a light source side optical surface of the first lens group LG1 that is closest to the light source is convex toward the light source side.

In FIG. 38, a spatial light modulator is arranged at the position of diaphragm STO, or a relay lens is arranged so that an image of the spatial light modulator may be formed at this position. A diffraction angle of a light flux diffracted by a cell of the spatial light modulator is dependent on a size of the cell, and a diffraction angle was set to 0.86° in the present example. A light flux with wavelength λ1 entering from the spatial light modulator changes into a collimated light flux after being transmitted through an objective lens, and it records interference fringes formed through interference with reference light, on hologram recording medium OD.

On the other hand, as for a light flux with wavelength λ2 for tracking and focusing operations, its optical path is adjusted to a light flux with wavelength λ1 by a dichroic mirror, and then, the light flux is restricted by diaphragm STO, thus the light flux converged by the objective lens is transmitted through a hologram recording layer to be focused on a layer on which pits for servo are recorded.

In Table 13, (a) represents lens data, (b) represents aspheric surface data, (c) represents wavefront aberration data on a light flux with wavelength λ1 having passed through the first optical system at the image height portions provided by dividing the image height into 10 portions at the position of diaphragm STO, and (d) represents wavefront aberration data on a light flux with wavelength λ2 having passed through the second optical system. When a light flux with wavelength λ1 passes through an objective lens, a maximum object height is −0.61 mm, NA on the object side is 0.015 and a focal length is 1 mm. On the other hand, when a light flux with wavelength λ2 passes through an objective lens, a diaphragm diameter is 1.23 mm and NA on the object side is 0.6. In the present example, P2/Pt=−0.648 and |νp−νn|=31.65 hold.

In Table 13, (c) indicates that wavefront aberration of a light flux with wavelength λ1 having passed through the first optical system at each image height portion at the position of diaphragm STO is properly corrected. Further, (d) in Table 1 indicates that wavefront aberration of a light flux with wavelength λ2 having passed through the second optical system is properly corrected.

TABLE 13
(a) Lens data table

| | | d | d | | | | | |
|---|---|---|---|---|---|---|---|---|
| | | (Optical | (Optical | | | | | |
| Surface | | system | system | | | | | |
| No. | r | 1) | 2) | n (λ1) | n (λ2) | nd | νd | Remarks |
| 0 | — | 0 | ∞ | | | | | |
| STO | ∞ | 0.050 | 0.050 | | | | | Diaphragm |
| 2 | 1.09879 | 0.310 | 0.310 | 1.798236 | 1.768168 | 1.7725 | 49.6 | TAF1_HOYA |
| 3 | 10.53733 | 0.040 | 0.040 | | | | | |
| 4 | 44.30300 | 0.120 | 0.120 | 1.911736 | 1.837276 | 1.846663 | 23.8 | FDS90_HOYA |
| 5 | 1.36120 | 0.770 | 0.770 | | | | | |
| 6 | 0.41914 | 0.630 | 0.630 | 1.604728 | 1.586417 | 1.58913 | 61.3 | MBACD5N_HOYA |
| 7 | 1.02284 | 0.050 | 0.050 | | | | | |
| 8 | ∞ | 0.300 | 0.300 | 1.506074 | 1.489154 | — | — | Hologram |
| | | | | | | | | recording |
| | | | | | | | | medium |
| 9 | ∞ | 0 | 0 | | | | | |

(b) Aspheric surface data

| | 6^{th} surface | 7^{th} surface |
|---|---|---|
| k | −1.45496E−01 | −7.90965E+00 |
| A4 | −1.46224E−01 | 8.80210E+00 |
| A6 | −1.99584E−01 | 3.36648E+02 |
| A8 | 5.25510E+00 | −1.58220E+04 |
| A10 | −7.69248E+01 | 4.35850E+05 |
| A12 | 2.70400E+02 | −5.19566E−02 |

(c) Wavefront aberration data of optical system 1 (λ1)

| Image height | Wavefront aberration |
|---|---|
| (mm) | (λrms) |
| 0.00 | 0.001 |
| 0.06 | 0.000 |
| 0.12 | 0.000 |
| 0.18 | 0.001 |
| 0.24 | 0.002 |
| 0.30 | 0.003 |
| 0.37 | 0.003 |
| 0.43 | 0.003 |
| 0.49 | 0.004 |
| 0.55 | 0.005 |
| 0.61 | 0.005 |

(d) Wavefront aberration data of optical system 2 (λ2)

| | Wavefront aberration |
|---|---|
| | (λrms) |
| Optical | 0.002 |
| system 2 | |

In Example 13, the 5^{th} surface and the 6^{th} surface only are made to be an aspheric surface, which is apparent from aspheric surface data in Table 13 showing conic constant κ and aspheric surface coefficient A2i of each surface.

### Example 14

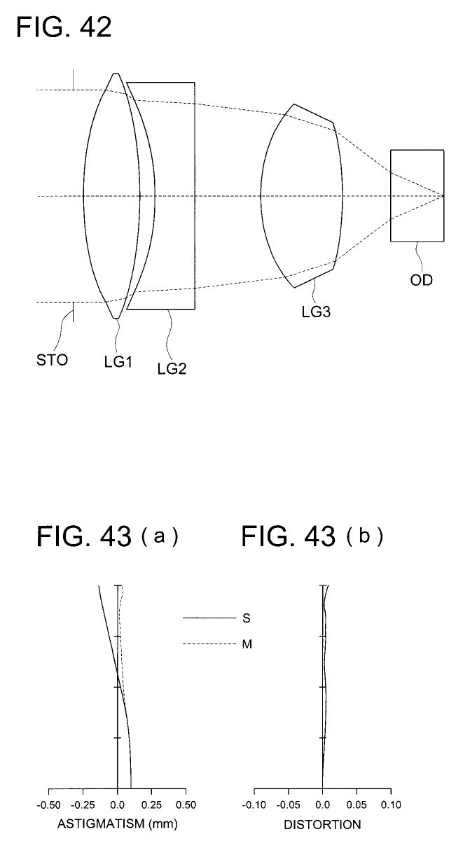

Each of FIG. 41 and FIG. 42 is a cross-sectional view relating to Example 14 of an objective lens capable of being used for an optical pickup apparatus shown in FIG. 1. FIG. 41 shows an optical path of a violet laser light (wavelength λ1) in the case of recording and/or reproducing of information, while, FIG. 42 shows an optical path of a red laser light (wavelength λ2) for focusing and tracking. FIG. 43(a) is a diagram showing a curvature of the field on a light-receiving element and FIG. 43(b) is a diagram showing distortion on a light-receiving element, both in the case of reproducing hologram in the present embodiment. In each of FIG. 41 and FIG. 42, an objective lens has therein positive first lens group LG1, negative second lens group LG2 and positive third lens group LG3 in this order from the light source side, and a light source side optical surface of the first lens group LG1 that is closest to the light source is convex toward the light source side.

In FIG. 41, a spatial light modulator is arranged at the position of diaphragm STO, or a relay lens is arranged so that an image of the spatial light modulator may be formed at this position. A diffraction angle of a light flux diffracted by a cell of the spatial light modulator is dependent on a size of the cell, and a diffraction angle was set to 0.86° in the present example. A light flux with wavelength λ1 entering from the spatial light modulator changes into a collimated light flux after being transmitted through an objective lens, and it records interference fringes formed through interference with reference light, on hologram recording medium OD.

On the other hand, as for a light flux with wavelength λ2 for tracking and focusing operations, its optical path is adjusted to a light flux with wavelength λ1 by a dichroic mirror, and then, the light flux is restricted by diaphragm STO, thus the light flux converged by the objective lens is transmitted through a hologram recording layer to be focused on a layer on which pits for servo are recorded.

In Table 14, (a) represents lens data, (b) represents aspheric surface data, (c) represents wavefront aberration data on a light flux with wavelength λ1 having passed through the first optical system at the image height portions provided by dividing the image height into 10 portions at the position of diaphragm STO, and (d) represents wavefront aberration data on a light flux with wavelength λ2 having passed through the second optical system. When a light flux with wavelength λ1 passes through an objective lens, a maximum object height is −0.61 mm, NA on the object side is 0.015 and a focal length is 1 mm. On the other hand, when a light flux with wavelength λ2 passes through an objective lens, a diaphragm diameter is 1.23 mm and NA on the object side is 0.6. In the present example, P2/Pt=−0.657 and |νp−νn|=31.65 hold.

In Table 14, (c) indicates that wavefront aberration of a light flux with wavelength λ1 having passed through the first optical system at each image height portion at the position of diaphragm STO is properly corrected. Further, (d) in Table 1 indicates that wavefront aberration of a light flux with wavelength λ2 having passed through the second optical system is properly corrected.

TABLE 14
(a) Lens data table

| | | d | d | | | | | |
|---|---|---|---|---|---|---|---|---|
| | | (Optical | (Optical | | | | | |
| Surface | | system | system | | | | | |
| No. | r | 1) | 2) | n (λ1) | n (λ2) | nd | νd | Remarks |
| 0 | — | 0 | ∞ | | | | | |
| STO | ∞ | 0.050 | 0.050 | | | | | Diaphragm |
| 2 | 1.53992 | 0.320 | 0.320 | 1.798236 | 1.768168 | 1.7725 | 49.6 | TAF1_HOYA |
| 3 | −2.16054 | 0.080 | 0.080 | | | | | |
| 4 | −1.39019 | 0.230 | 0.230 | 1.911736 | 1.837276 | 1.846663 | 23.8 | FDS90_HOYA |
| 5 | 973.44967 | 0.370 | 0.370 | | | | | |
| 6 | 0.88369 | 0.460 | 0.460 | 1.604728 | 1.586417 | 1.58913 | 61.3 | MBACD5N_HOYA |
| 7 | −1.26205 | 0.270 | 0.270 | | | | | |
| 8 | ∞ | 0.300 | 0.300 | 1.506074 | 1.489154 | — | — | Hologram |
| | | | | | | | | recording |
| | | | | | | | | medium |
| 9 | ∞ | 0 | 0 | | | | | |

(b) Aspheric surface data

| | 6^{th} surface | 7^{th} surface |
|---|---|---|
| k | −4.68457E+00 | −8.06358E−01 |
| A4 | 6.60592E−01 | 2.52022E−01 |
| A6 | −3.36315E−01 | 5.73432E+00 |
| A8 | −7.15596E−02 | −5.71346E+01 |
| A10 | 3.26686E+00 | 3.06149E+02 |
| A12 | 2.92252E+01 | −5.22647E+02 |

(c) Wavefront aberration data of optical system 1 (λ1)

| Image height | Wavefront aberration |
|---|---|
| (mm) | (λrms) |
| 0.00 | 0.008 |
| 0.06 | 0.008 |
| 0.12 | 0.007 |
| 0.18 | 0.006 |
| 0.24 | 0.004 |
| 0.30 | 0.003 |
| 0.37 | 0.003 |
| 0.43 | 0.004 |
| 0.49 | 0.006 |
| 0.55 | 0.008 |
| 0.61 | 0.009 |

(d) Wavefront aberration data of optical system 2 (λ2)

| | Wavefront aberration |
|---|---|
| | (λrms) |
| Optical | 0.007 |
| system 2 | |

In Example 14, the 5^{th} surface and the 6^{th} surface only are made to be an aspheric surface, which is apparent from aspheric surface data in Table 14 showing conic constant κ and aspheric surface coefficient A2i of each surface.

### Example 15

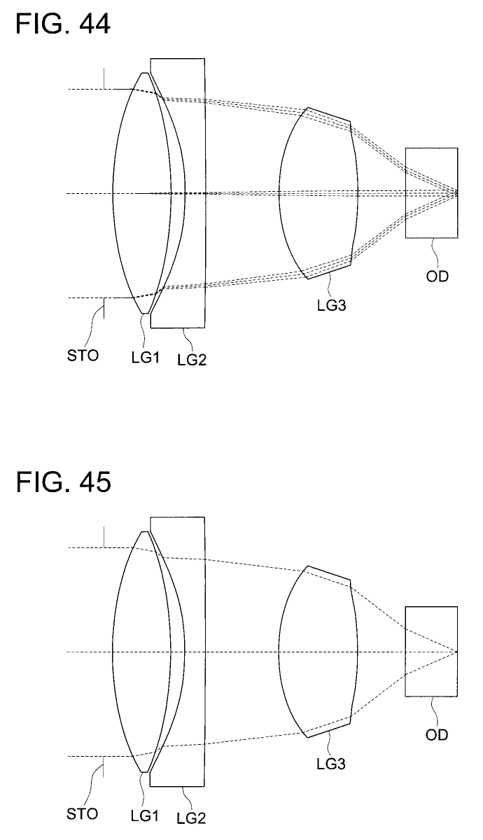

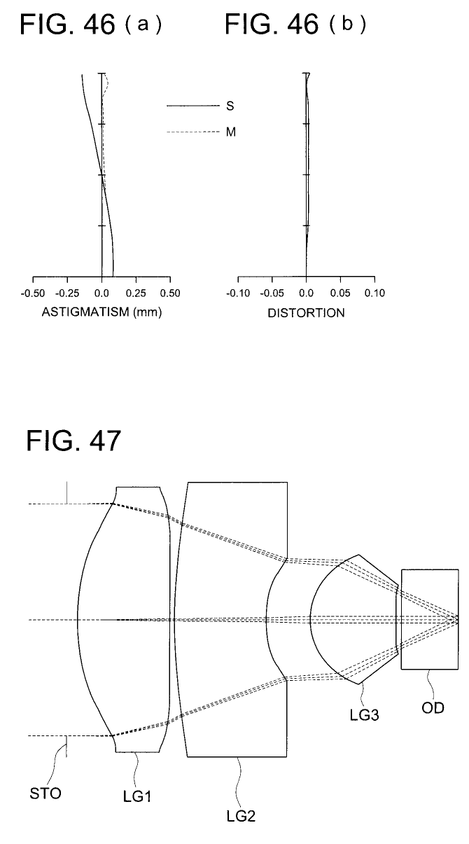

Each of FIG. 44 and FIG. 45 is a cross-sectional view relating to Example 15 of an objective lens capable of being used for an optical pickup apparatus shown in FIG. 1. FIG. 44 shows an optical path of a violet laser light (wavelength λ1) in the case of recording and/or reproducing of information, while, FIG. 45 shows an optical path of a red laser light (wavelength λ2) for focusing and tracking. FIG. 46(a) is a diagram showing a curvature of the field on a light-receiving element and FIG. 46(b) is a diagram showing distortion on a light-receiving element, both in the case of reproducing hologram in the present embodiment. In each of FIG. 44 and FIG. 45, an objective lens has therein positive first lens group LG1, negative second lens group LG2 and positive third lens group LG3 in this order from the light source side, and a light source side optical surface of the first lens group LG1 that is closest to the light source is convex toward the light source side.

In FIG. 44, a spatial light modulator is arranged at the position of diaphragm STO, or a relay lens is arranged so that an image of the spatial light modulator may be formed at this position. A diffraction angle of a light flux diffracted by a cell of the spatial light modulator is dependent on a size of the cell, and a diffraction angle was set to 0.86° in the present example. A light flux with wavelength λ1 entering from the spatial light modulator changes into a collimated light flux after being transmitted through an objective lens, and it records interference fringes formed through interference with reference light, on hologram recording medium OD.

On the other hand, as for a light flux with wavelength λ2 for tracking and focusing operations, its optical path is adjusted to a light flux with wavelength λ1 by a dichroic mirror, and then, the light flux is restricted by diaphragm STO, thus the light flux converged by the objective lens is transmitted through a hologram recording layer to be focused on a layer on which pits for servo are recorded.

In Table 15, (a) represents lens data, (b) represents aspheric surface data, (c) represents wavefront aberration data on a light flux with wavelength λ1 having passed through the first optical system at the image height portions provided by dividing the image height into 10 portions at the position of diaphragm STO, and (d) represents wavefront aberration data on a light flux with wavelength λ2 having passed through the second optical system. When a light flux with wavelength λ1 passes through an objective lens, a maximum object height is −0.61 mm, NA on the object side is 0.015 and a focal length is 1 mm. On the other hand, when a light flux with wavelength λ2 passes through an objective lens, a diaphragm diameter is 1.23 mm and NA on the object side is 0.6. In the present example, P2/Pt=−0.662 and |νp−νn|=31.65 hold.

In Table 15, (c) indicates that wavefront aberration of a light flux with wavelength λ1 having passed through the first optical system at each image height portion at the position of diaphragm STO is properly corrected. Further, (d) in Table 1 indicates that wavefront aberration of a light flux with wavelength λ2 having passed through the second optical system is properly corrected.

TABLE 15
(a) Lens data table

| | | d | d | | | | | |
|---|---|---|---|---|---|---|---|---|
| | | (Optical | (Optical | | | | | |
| Surface | | system | system | | | | | |
| No. | r | 1) | 2) | n (λ1) | n (λ2) | nd | νd | Remarks |
| 0 | — | 0 | ∞ | | | | | |
| STO | ∞ | 0.050 | 0.050 | | | | | Diaphragm |
| 2 | 1.59359 | 0.330 | 0.330 | 1.798236 | 1.768168 | 1.7725 | 49.6 | TAF1_HOYA |
| 3 | −1.98821 | 0.080 | 0.080 | | | | | |
| 4 | −1.30149 | 0.120 | 0.120 | 1.911736 | 1.837276 | 1.846663 | 23.8 | FDS90_HOYA |
| 5 | −24.39024 | 0.430 | 0.430 | | | | | |
| 6 | 0.90785 | 0.460 | 0.460 | 1.604728 | 1.586417 | 1.58913 | 61.3 | MBACD5N_HOYA |
| 7 | −1.21830 | 0.270 | 0.270 | | | | | |
| 8 | ∞ | 0.300 | 0.300 | 1.506074 | 1.489154 | — | — | Hologram |
| | | | | | | | | recording |
| | | | | | | | | medium |
| 9 | ∞ | 0 | 0 | | | | | |

(b) Aspheric surface data

| | 6^{th} surface | 7^{th} surface |
|---|---|---|
| k | −5.03889E+00 | −1.06441E+00 |
| A4 | 6.70220E−01 | 2.65244E−01 |
| A6 | −2.27901E−01 | 6.08351E+00 |
| A8 | 2.18377E−01 | −5.67607E+01 |
| A10 | 3.72557E+00 | 3.03152E+02 |
| A12 | 3.58751E+01 | −4.63067E+02 |

(c) Wavefront aberration data of optical system 1 (λ1)

| Image height | Wavefront aberration |
|---|---|
| (mm) | (λrms) |
| 0.00 | 0.006 |
| 0.06 | 0.006 |
| 0.12 | 0.005 |
| 0.18 | 0.004 |
| 0.24 | 0.002 |
| 0.30 | 0.001 |
| 0.37 | 0.003 |
| 0.43 | 0.005 |
| 0.49 | 0.007 |
| 0.55 | 0.009 |
| 0.61 | 0.010 |

(d) Wavefront aberration data of optical system 2 (λ2)

| | Wavefront aberration |
|---|---|
| | (λrms) |
| Optical | 0.008 |
| system 2 | |

In Example 15, the 5^{th} surface and the 6^{th} surface only are made to be an aspheric surface, which is apparent from aspheric surface data in Table 15 showing conic constant κ and aspheric surface coefficient A2i of each surface.

### Example 16

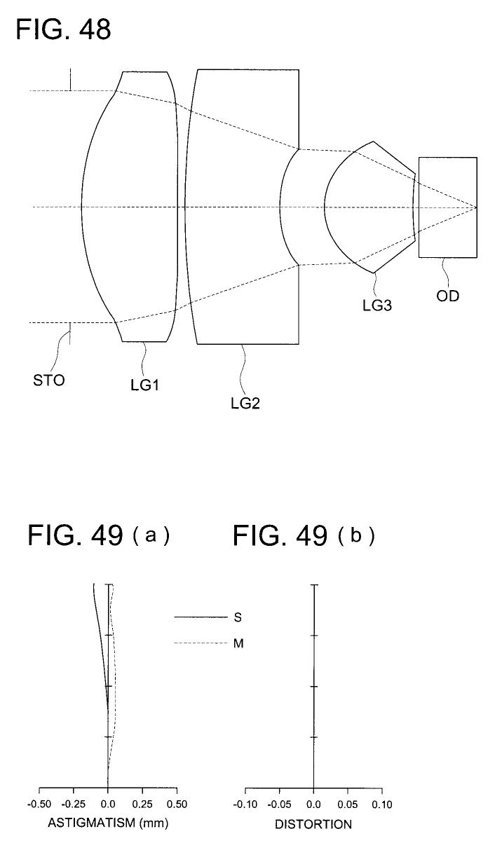

Each of FIG. 47 and FIG. 48 is a cross-sectional view relating to Example 16 of an objective lens capable of being used for an optical pickup apparatus shown in FIG. 1. FIG. 47 shows an optical path of a violet laser light (wavelength λ1) in the case of recording and/or reproducing of information, while, FIG. 48 shows an optical path of a red laser light (wavelength λ2) for focusing and tracking. FIG. 49(a) is a diagram showing a curvature of the field on a light-receiving element and FIG. 49(b) is a diagram showing distortion on a light-receiving element, both in the case of reproducing hologram in the present embodiment. In each of FIG. 47 and FIG. 48, an objective lens has therein positive first lens group LG1, negative second lens group LG2 and positive third lens group LG3 in this order from the light source side, and a light source side optical surface of the first lens group LG1 that is closest to the light source is convex toward the light source side.

In FIG. 47, a spatial light modulator is arranged at the position of diaphragm STO, or a relay lens is arranged so that an image of the spatial light modulator may be formed at this position. A diffraction angle of a light flux diffracted by a cell of the spatial light modulator is dependent on a size of the cell, and a diffraction angle was set to 0.86° in the present example. A light flux with wavelength λ1 entering from the spatial light modulator changes into a collimated light flux after being transmitted through an objective lens, and it records interference fringes formed through interference with reference light, on hologram recording medium OD.

On the other hand, as for a light flux with wavelength λ2 for tracking and focusing operations, its optical path is adjusted to a light flux with wavelength λ1 by a dichroic mirror, and then, the light flux is restricted by diaphragm STO, thus the light flux converged by the objective lens is transmitted through a hologram recording layer to be focused on a layer on which pits for servo are recorded.

In Table 16, (a) represents lens data, (b) represents aspheric surface data, (c) represents wavefront aberration data on a light flux with wavelength λ1 having passed through the first optical system at the image height portions provided by dividing the image height into 10 portions at the position of diaphragm STO, and (d) represents wavefront aberration data on a light flux with wavelength λ2 having passed through the second optical system. When a light flux with wavelength λ1 passes through an objective lens, a maximum object height is −0.61 mm, NA on the object side is 0.015 and a focal length is 1 mm. On the other hand, when a light flux with wavelength λ2 passes through an objective lens, a diaphragm diameter is 1.23 mm and NA on the object side is 0.6. In the present example, P2/Pt=−1.387 and |νp−νn|=31.15 hold.

In Table 16, (c) indicates that wavefront aberration of a light flux with wavelength λ1 having passed through the first optical system at each image height portion at the position of diaphragm STO is properly corrected. Further, (d) in Table 1 indicates that wavefront aberration of a light flux with wavelength λ2 having passed through the second optical system is properly corrected.

TABLE 16
(a) Lens data table

| | | d | d | | | | | |
|---|---|---|---|---|---|---|---|---|
| | | (Optical | (Optical | | | | | |
| Surface | | system | system | | | | | |
| No. | r | 1) | 2) | n (λ1) | n (λ2) | nd | νd | Remarks |
| 0 | — | 0 | ∞ | | | | | |
| STO | ∞ | 0.050 | 0.050 | | | | | Diaphragm |
| 2 | 1.02803 | 0.490 | 0.490 | 1.798236 | 1.768168 | 1.7725 | 49.6 | TAF1_HOYA |
| 3 | −441.04582 | 0.030 | 0.030 | | | | | |
| 4 | 3.67385 | 0.490 | 0.490 | 1.911736 | 1.837276 | 1.846663 | 23.8 | FDS90_HOYA |
| 5 | 0.52222 | 0.230 | 0.230 | | | | | |
| 6 | 0.34406 | 0.450 | 0.450 | 1.637136 | 1.617519 | 1.620409 | 60.3 | BACD16_HOYA |
| 7 | −28.15779 | 0.030 | 0.030 | | | | | |
| 8 | ∞ | 0.300 | 0.300 | 1.506074 | 1.489154 | — | — | Hologram |
| | | | | | | | | recording |
| | | | | | | | | medium |
| 9 | ∞ | 0 | 0 | | | | | |

(b) Aspheric surface data

| | 2^{nd} surface | 3^{rd} surface | 6^{th} surface | 7^{th} surface |
|---|---|---|---|---|
| k | −1.60681E−01 | −6.51593E−16 | −8.61208E−02 | −1.10000E+01 |
| A4 | −1.98505E−02 | −1.51548E−02 | −5.25085E−01 | 1.06881E+01 |
| A6 | −4.88645E−02 | 4.43502E−02 | 1.73827E+01 | 5.86480E+01 |
| A8 | −2.75334E−01 | −7.98126E−01 | −3.32717E+02 | −8.34162E+02 |
| A10 | 1.06199E+00 | −4.97961E+00 | 2.90706E+03 | 5.81458E+04 |
| A12 | −4.43971E+00 | 9.08921E+00 | −1.18023E+04 | −5.18340E−02 |

(c) Wavefront aberration data of optical system 1 (λ1)

| Image height | Wavefront aberration |
|---|---|
| (mm) | (λrms) |
| 0.00 | 0.000 |
| 0.06 | 0.001 |
| 0.12 | 0.002 |
| 0.18 | 0.003 |
| 0.24 | 0.004 |
| 0.30 | 0.004 |
| 0.37 | 0.004 |
| 0.43 | 0.005 |
| 0.49 | 0.006 |
| 0.55 | 0.007 |
| 0.61 | 0.008 |

(d) Wavefront aberration data of optical system 2 (λ2)

| | Wavefront aberration |
|---|---|
| | (λrms) |
| Optical | 0.005 |
| system 2 | |

In Example 16, the 1^{st} surface, the 2^{nd} surface, the 5^{th} surface and the 6^{th} surface only are made to be an aspheric surface, which is apparent from aspheric surface data in Table 16 showing conic constant κ and aspheric surface coefficient A2i of each surface.

### Example 17

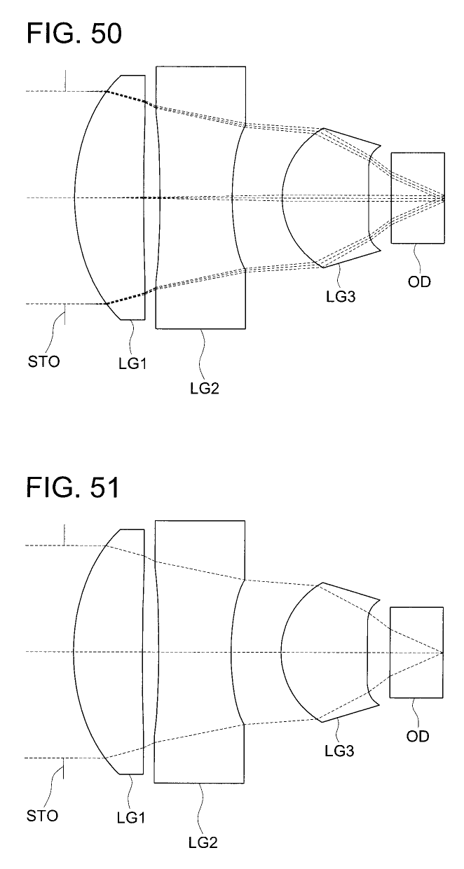

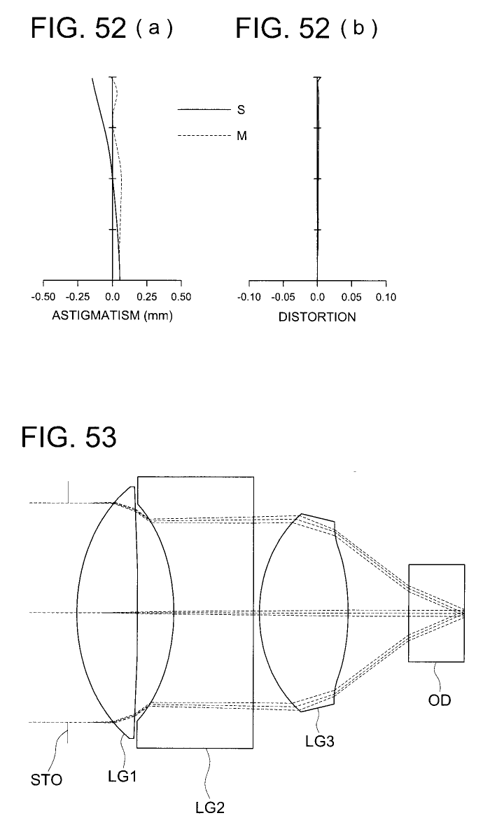

Each of FIG. 50 and FIG. 51 is a cross-sectional view relating to Example 17 of an objective lens capable of being used for an optical pickup apparatus shown in FIG. 1. FIG. 50 shows an optical path of a violet laser light (wavelength λ1) in the case of recording and/or reproducing of information, while, FIG. 51 shows an optical path of a red laser light (wavelength λ2) for focusing and tracking. FIG. 52(a) is a diagram showing a curvature of the field on a light-receiving element and FIG. 52(b) is a diagram showing distortion on a light-receiving element, both in the case of reproducing hologram in the present embodiment. In each of FIG. 50 and FIG. 51, an objective lens has therein positive first lens group LG1, negative second lens group LG2 and positive third lens group LG3 in this order from the light source side, and a light source side optical surface of the first lens group LG1 that is closest to the light source is convex toward the light source side.

In Table 17, (c) indicates that wavefront aberration of a light flux with wavelength λ1 having passed through the first optical system at each image height portion at the position of diaphragm STO is properly corrected. Further, (d) in Table 1 indicates that wavefront aberration of a light flux with wavelength λ2 having passed through the second optical system is properly corrected.

In FIG. 50, a spatial light modulator is arranged at the position of diaphragm STO, or a relay lens is arranged so that an image of the spatial light modulator may be formed at this position. A diffraction angle of a light flux diffracted by a cell of the spatial light modulator is dependent on a size of the cell, and a diffraction angle was set to 0.86° in the present example. A light flux with wavelength λ1 entering from the spatial light modulator changes into a collimated light flux after being transmitted through an objective lens, and it records interference fringes formed through interference with reference light, on hologram recording medium OD.

On the other hand, as for a light flux with wavelength λ2 for tracking and focusing operations, its optical path is adjusted to a light flux with wavelength λ1 by a dichroic mirror, and then, the light flux is restricted by diaphragm STO, thus the light flux converged by the objective lens is transmitted through a hologram recording layer to be focused on a layer on which pits for servo are recorded.

In Table 17, (a) represents lens data, (b) represents aspheric surface data, (c) represents wavefront aberration data on a light flux with wavelength λ1 having passed through the first optical system at the image height portions provided by dividing the image height into 10 portions at the position of diaphragm STO, and (d) represents wavefront aberration data on a light flux with wavelength λ2 having passed through the second optical system. When a light flux with wavelength λ1 passes through an objective lens, a maximum object height is −0.61 mm, NA on the object side is 0.015 and a focal length is 1 mm. On the other hand, when a light flux with wavelength λ2 passes through an objective lens, a diaphragm diameter is 1.23 mm and NA on the object side is 0.6. In the present example, P2/Pt=−0.873 and |νp−νn|=31.65 hold.

TABLE 17
(a) Lens data table

| | | d | d | | | | | |
|---|---|---|---|---|---|---|---|---|
| | | (Optical | (Optical | | | | | |
| Surface | | system | system | | | | | |
| No. | r | 1) | 2) | n (λ1) | n (λ2) | nd | νd | Remarks |
| 0 | — | 0 | ∞ | | | | | |
| STO | ∞ | 0.050 | 0.050 | | | | | Diaphragm |
| 2 | 1.08758 | 0.380 | 0.380 | 1.798236 | 1.768168 | 1.7725 | 49.6 | TAF1_HOYA |
| 3 | 15.26225 | 0.090 | 0.090 | | | | | |
| 4 | −6.76681 | 0.410 | 0.410 | 1.911736 | 1.837276 | 1.846663 | 23.8 | FDS90_HOYA |
| 5 | 1.27092 | 0.280 | 0.280 | | | | | |
| 6 | 0.44020 | 0.490 | 0.490 | 1.604728 | 1.586417 | 1.58913 | 61.3 | MBACD5N_HOYA |
| 7 | −7.25238 | 0.130 | 0.130 | | | | | |
| 8 | ∞ | 0.300 | 0.300 | 1.506074 | 1.489154 | — | — | Hologram |
| | | | | | | | | recording |
| | | | | | | | | medium |
| 9 | ∞ | 0 | 0 | | | | | |

(b) Aspheric surface data

| | 6^{th} surface | 7^{th} surface |
|---|---|---|
| k | 2.40344E−25 | −5.16145E−21 |
| A4 | −3.48866E−01 | 4.01159E+00 |
| A6 | −5.28125E−04 | 2.13425E+01 |
| A8 | −4.92166E−01 | −7.42612E+02 |
| A10 | −9.83224E+01 | 1.37072E+04 |
| A12 | 5.56265E+02 | −5.19568E−02 |

(c) Wavefront aberration data of optical system 1 (λ1)

| Image height | Wavefront aberration |
|---|---|
| (mm) | (λrms) |
| 0.00 | 0.004 |
| 0.06 | 0.004 |
| 0.12 | 0.004 |
| 0.18 | 0.004 |
| 0.24 | 0.004 |
| 0.30 | 0.004 |
| 0.37 | 0.004 |
| 0.43 | 0.004 |
| 0.49 | 0.005 |
| 0.55 | 0.008 |
| 0.61 | 0.010 |

(d) Wavefront aberration data of optical system 2 (λ2)

| | Wavefront aberration |
|---|---|
| | (λrms) |
| Optical | 0.004 |
| system 2 | |

In Example 17, the 5^{th} surface and the 6^{th} surface only are made to be an aspheric surface, which is apparent from aspheric surface data in Table 17 showing conic constant κ and aspheric surface coefficient A2i of each surface.

### Example 18

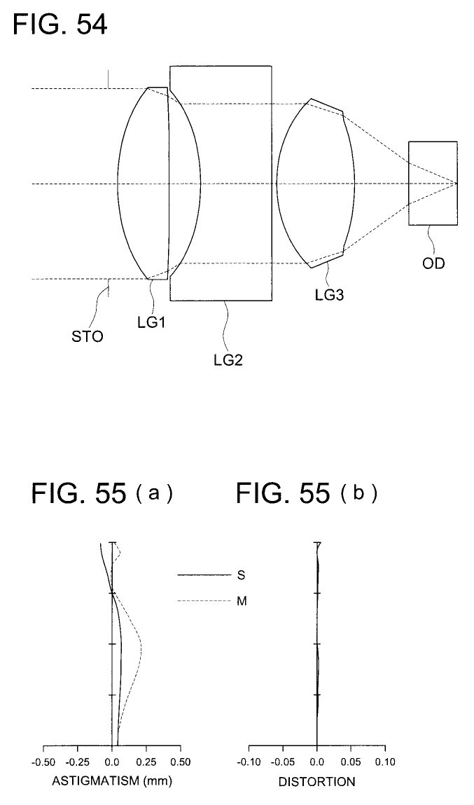

Each of FIG. 53 and FIG. 54 is a cross-sectional view relating to Example 18 of an objective lens capable of being used for an optical pickup apparatus shown in FIG. 1. FIG. 53 shows an optical path of a violet laser light (wavelength λ1) in the case of recording and/or reproducing of information, while, FIG. 54 shows an optical path of a red laser light (wavelength λ2) for focusing and tracking. FIG. 55(a) is a diagram showing a curvature of the field on a light-receiving element and FIG. 55(b) is a diagram showing distortion on a light-receiving element, both in the case of reproducing hologram in the present embodiment. In each of FIG. 53 and FIG. 54, an objective lens has therein positive first lens group LG1, negative second lens group LG2 and positive third lens group LG3 in this order from the light source side, and a light source side optical surface of the first lens group LG1 that is closest to the light source is convex toward the light source side.

In FIG. 53, a spatial light modulator is arranged at the position of diaphragm STO, or a relay lens is arranged so that an image of the spatial light modulator may be formed at this position. A diffraction angle of a light flux diffracted by a cell of the spatial light modulator is dependent on a size of the cell, and a diffraction angle was set to 0.86° in the present example. A light flux with wavelength λ1 entering from the spatial light modulator changes into a collimated light flux after being transmitted through an objective lens, and it records interference fringes formed through interference with reference light, on hologram recording medium OD.

On the other hand, as for a light flux with wavelength λ2 for tracking and focusing operations, its optical path is adjusted to a light flux with wavelength λ1 by a dichroic mirror, and then, the light flux is restricted by diaphragm STO, thus the light flux converged by the objective lens is transmitted through a hologram recording layer to be focused on a layer on which pits for servo are recorded.

In Table 18, (a) represents lens data, (b) represents aspheric surface data, (c) represents wavefront aberration data on a light flux with wavelength λ1 having passed through the first optical system at the image height portions provided by dividing the image height into 10 portions at the position of diaphragm STO, and (d) represents wavefront aberration data on a light flux with wavelength λ2 having passed through the second optical system. When a light flux with wavelength λ1 passes through an objective lens, a maximum object height is −0.61 mm, NA on the object side is 0.015 and a focal length is 1 mm. On the other hand, when a light flux with wavelength λ2 passes through an objective lens, a diaphragm diameter is 1.23 mm and NA on the object side is 0.6. In the present example, P2/Pt=−0.871 and |νp−νn|=31.65 hold.

In Table 18, (c) indicates that wavefront aberration of a light flux with wavelength λ1 having passed through the first optical system at each image height portion at the position of diaphragm STO is properly corrected. Further, (d) in Table 1 indicates that wavefront aberration of a light flux with wavelength λ2 having passed through the second optical system is properly corrected.

TABLE 18
(a) Lens data table

| | | d | d | | | | | |
|---|---|---|---|---|---|---|---|---|
| | | (Optical | (Optical | | | | | |
| Surface | | system | system | | | | | |
| No. | r | 1) | 2) | n (λ1) | n (λ2) | nd | νd | Remarks |
| 0 | — | 0 | ∞ | | | | | |
| STO | ∞ | 0.050 | 0.050 | | | | | Diaphragm |
| 2 | 1.10997 | 0.320 | 0.320 | 1.798236 | 1.768168 | 1.7725 | 49.6 | TAF1_HOYA |
| 3 | 55.24438 | 0.200 | 0.200 | | | | | |
| 4 | −1.01874 | 0.440 | 0.440 | 1.911736 | 1.837276 | 1.846663 | 23.8 | FDS90_HOYA |
| 5 | −46.78646 | 0.030 | 0.030 | | | | | |
| 6 | 0.79185 | 0.490 | 0.490 | 1.604728 | 1.586417 | 1.58913 | 61.3 | MBACD5N_HOYA |
| 7 | −0.82873 | 0.330 | 0.330 | | | | | |
| 8 | ∞ | 0.300 | 0.300 | 1.506074 | 1.489154 | — | — | Hologram |
| | | | | | | | | recording |
| | | | | | | | | medium |
| 9 | ∞ | 0 | 0 | | | | | |

(b) Aspheric surface data

| | 2^{nd} surface | 3^{rd} surface | 4^{th} surface | 5^{th} surface | 6^{th} surface | 7^{th} surface |
|---|---|---|---|---|---|---|
| k | −4.04870E−01 | 0.00000E+00 | 1.90233E−02 | 1.81977E+03 | −5.83368E−01 | −1.67599E−02 |
| A4 | −9.45707E−02 | −2.40433E−01 | −4.46224E−01 | −9.70325E−03 | 7.03694E−01 | 3.10416E+00 |
| A6 | 3.16511E−01 | −1.59496E−02 | −4.10407E−03 | −9.70115E−03 | −5.47623E+00 | −2.47412E+01 |
| A8 | 3.17824E−02 | 1.37564E+00 | −3.94668E−03 | 2.41753E−02 | 2.32255E+01 | 1.46811E+02 |
| A10 | 1.58527E+00 | 1.87556E+00 | 5.02358E−02 | 3.34924E−01 | −7.33991E+01 | −4.89711E+02 |
| A12 | −7.24556E−01 | −8.43372E+00 | −1.92768E−01 | −3.75078E−01 | 1.42324E+02 | 7.94605E+02 |

(c) Wavefront aberration data of optical system 1 (λ1)

| Image height | Wavefront aberration |
|---|---|
| (mm) | (λrms) |
| 0.00 | 0.003 |
| 0.06 | 0.004 |
| 0.12 | 0.006 |
| 0.18 | 0.009 |
| 0.24 | 0.011 |
| 0.30 | 0.012 |
| 0.37 | 0.010 |
| 0.43 | 0.004 |
| 0.49 | 0.001 |
| 0.55 | 0.004 |
| 0.61 | 0.009 |

(d) Wavefront aberration data of optical system 2 (λ2)

| | Wavefront aberration |
|---|---|
| | (λrms) |
| Optical | 0.004 |
| system 2 | |

In Example 18, all of the 1^{st}-the 6^{th} surfaces are made to be an aspheric surface, which is apparent from aspheric surface data in Table 18 showing conic constant κ and aspheric surface coefficient A2i of each surface.

### Example 19

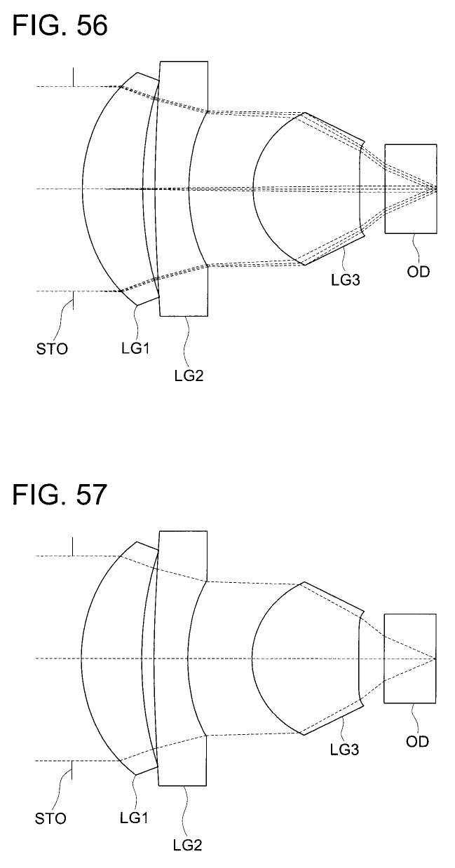

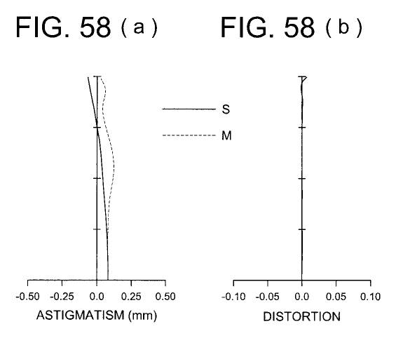

Each of FIG. 56 and FIG. 57 is a cross-sectional view relating to Example 19 of an objective lens capable of being used for an optical pickup apparatus shown in FIG. 1. FIG. 56 shows an optical path of a violet laser light (wavelength λ1) in the case of recording and/or reproducing of information, while, FIG. 57 shows an optical path of a red laser light (wavelength λ2) for focusing and tracking. FIG. 58(a) is a diagram showing a curvature of the field on a light-receiving element and FIG. 58(b) is a diagram showing distortion on a light-receiving element, both in the case of reproducing hologram in the present embodiment. In each of FIG. 56 and FIG. 57, an objective lens has therein positive first lens group LG1, negative second lens group LG2 and positive third lens group LG3 in this order from the light source side, and a light source side optical surface of the first lens group LG1 that is closest to the light source is convex toward the light source side.

In FIG. 56, a spatial light modulator is arranged at the position of diaphragm STO, or a relay lens is arranged so that an image of the spatial light modulator may be formed at this position. A diffraction angle of a light flux diffracted by a cell of the spatial light modulator is dependent on a size of the cell, and a diffraction angle was set to 0.86° in the present example. A light flux with wavelength λ1 entering from the spatial light modulator changes into a collimated light flux after being transmitted through an objective lens, and it records interference fringes formed through interference with reference light, on hologram recording medium OD.

On the other hand, as for a light flux with wavelength λ2 for tracking and focusing operations, its optical path is adjusted to a light flux with wavelength λ1 by a dichroic mirror, and then, the light flux is restricted by diaphragm STO, thus the light flux converged by the objective lens is transmitted through a hologram recording layer to be focused on a layer on which pits for servo are recorded.

In Table 19, (a) represents lens data, (b) represents aspheric surface data, (c) represents wavefront aberration data on a light flux with wavelength λ1 having passed through the first optical system at the image height portions provided by dividing the image height into 10 portions at the position of diaphragm STO, and (d) represents wavefront aberration data on a light flux with wavelength λ2 having passed through the second optical system. When a light flux with wavelength λ1 passes through an objective lens, a maximum object height is −0.61 mm, NA on the object side is 0.015 and a focal length is 1 mm. On the other hand, when a light flux with wavelength λ2 passes through an objective lens, a diaphragm diameter is 1.23 mm and NA on the object side is 0.6. In the present example, P2/Pt=−0.816 and |νp−νn|=31.65 hold.

In Table 19, (c) indicates that wavefront aberration of a light flux with wavelength λ1 having passed through the first optical system at each image height portion at the position of diaphragm STO is properly corrected. Further, (d) in Table 1 indicates that wavefront aberration of a light flux with wavelength λ2 having passed through the second optical system is properly corrected.

TABLE 19
(a) Lens data table

| | | d | d | | | | | |
|---|---|---|---|---|---|---|---|---|
| | | (Optical | (Optical | | | | | |
| Surface | | system | system | | | | | |
| No. | r | 1) | 2) | n (λ1) | n (λ2) | nd | νd | Remarks |
| 0 | — | 0 | ∞ | | | | | |
| STO | ∞ | 0.050 | 0.050 | | | | | Diaphragm |
| 2 | 0.92410 | 0.350 | 0.350 | 1.798236 | 1.768168 | 1.7725 | 49.6 | TAF1_HOYA |
| 3 | 2.37390 | 0.070 | 0.070 | | | | | |
| 4 | 9.29896 | 0.190 | 0.190 | 1.911736 | 1.837276 | 1.846663 | 23.8 | FDS90_HOYA |
| 5 | 0.98738 | 0.380 | 0.380 | | | | | |
| 6 | 0.45240 | 0.630 | 0.630 | 1.604728 | 1.586417 | 1.58913 | 61.3 | MBACD5N_HOYA |
| 7 | −6.11548 | 0.150 | 0.150 | | | | | |
| 8 | ∞ | 0.300 | 0.300 | 1.506074 | 1.489154 | — | — | Hologram |
| | | | | | | | | recording |
| | | | | | | | | medium |
| 9 | ∞ | 0 | 0 | | | | | |

(b) Aspheric surface data

| | 6^{th} surface | 7^{th} surface |
|---|---|---|
| k | −2.02498E−01 | −4.67667E−08 |
| A4 | −2.93780E−01 | 3.45337E+00 |
| A6 | −4.07143E−01 | 4.10673E+01 |
| A8 | 4.78153E+00 | −1.01834E+03 |
| A10 | −5.69597E+01 | 1.15211E+04 |
| A12 | 1.54430E+02 | −5.21475E−02 |

(c) Wavefront aberration data of optical system 1 (λ1)

| Image height | Wavefront aberration |
|---|---|
| (mm) | (λrms) |
| 0.00 | 0.006 |
| 0.06 | 0.006 |
| 0.12 | 0.005 |
| 0.18 | 0.005 |
| 0.24 | 0.006 |
| 0.30 | 0.007 |
| 0.37 | 0.007 |
| 0.43 | 0.006 |
| 0.49 | 0.004 |
| 0.55 | 0.005 |
| 0.61 | 0.005 |

(d) Wavefront aberration data of optical system 2 (λ2)

| | Wavefront aberration |
|---|---|
| | (λrms) |
| Optical | 0.004 |
| system 2 | |

In Example 19, the 5^{th} surface and the 6^{th} surface only are made to be an aspheric surface, which is apparent from aspheric surface data in Table 19 showing conic constant κ and aspheric surface coefficient A2i of each surface.

Table 20 shows collectively values corresponding to Expression (1) and Expression (2) for each Example.

TABLE 20

| Example | Values of | Values of |
|---|---|---|
| Nos. | Expression (1) | Expression (2) |
| 1 | 31.65 | −0.93 |
| 2 | 1.50 | −0.49 |
| 3 | 21.95 | −2.13 |
| 4 | 25.75 | −2.03 |
| 5 | 1.50 | −0.02 |
| 6 | 35.90 | −0.29 |
| 7 | 35.90 | −0.39 |
| 8 | 31.65 | −0.81 |
| 9 | 31.65 | −0.55 |
| 10 | 31.15 | −1.18 |
| 11 | 31.65 | −1.22 |
| 12 | 31.65 | −0.92 |
| 13 | 31.65 | −0.65 |
| 14 | 31.65 | −0.66 |
| 15 | 31.65 | −0.66 |
| 16 | 31.15 | −1.39 |
| 17 | 31.65 | −0.87 |
| 18 | 31.65 | −0.87 |
| 19 | 31.65 | −0.82 |

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

For example, the above examples employ an objective lens formed by three lens groups. However, the objective lens relating to the present invention may include three or more lens groups in which the first lens group closest to a light source has an optical surface facing the light source which is convex to a light source side, because it achieves at least the features that the resolution is enhanced over the whole area of an image formed by the objective lens for recording and/or reproducing information and the optical system of the objective lens is made to be small-sized. Furthermore, it is preferable that the first lens group has a positive refractive power, and at least one lens group of the plurality of lens groups has a negative refractive power.

As for the optical pickup apparatus, the above examples employ an optical pickup apparatus for holographic recording and/or reproducing which conducts the focusing and tracking operations by using a light flux whose wavelength is different from that for recording and/or reproducing of information. However, the optical pickup apparatus relating to the present invention may be provided as an optical pickup apparatus for holographic recording and/or reproducing by using a first light flux a predetermined wavelength which includes mainly the first optical system, for example, the first light source for emitting the first light flux; the collimating lens for collimating the first light flux emitted from the first light source; a first light splitting element for generating the reference light to be emitted on the recording layer out of the first light flux emitted by the collimating lens; a spatial light modulator; the objective lens; a second light splitting element arranged on an optical path between the objective lens and the spatial light modulator for splitting out the first light flux reflected by the recording layer; and the first photodetector. In the optical pickup apparatus, the objective lens is adopted to converge the object light on the recording layer so as to form a holographic image on the recording layer using the object light and the reference light. It provides the same effect to the above objective optical lens.

What is claimed is:

1. An objective lens for use in an optical pickup apparatus for recording and/or reproducing information on an optical information recording medium using holography, the objective lens comprising:
a plurality of lens groups including three or more lens groups,
wherein a first lens group closest to a light source of the optical pickup apparatus among the plurality of lens groups, comprises an optical surface closest to the light source being convex to a light source side.

2. The objective lens of claim 1,
wherein at least one lens group of the plurality of lens groups has a different Abbe number from the other lens groups.

3. The objective lens of claim 2, satisfying
21.9<|νp−νn|,
where νp is an average of Abbe numbers of positive lenses in the plurality of lens groups, and
νn is an average of Abbe numbers of negative lenses in the plurality of lens groups.

4. The objective lens of claim 1,
wherein the first lens group has a positive refractive power, and
at least one lens group of the plurality of lens groups has a negative refractive power.

5. The objective lens of claim 4,
wherein the plurality of lens groups consists of, in order from the light source side:
the first lens group having a positive refractive power;
a second lens group having a negative refractive power; and
a third lens group having a positive refractive power.

6. The objective lens of claim 1, satisfying
−2.2<P2/Pt<0,
where Pt is a refractive power of a whole of the objective lens, and P2 is a refractive power of a second lens group second closest to the light source.

7. The objective lens of claim 6, satisfying
−2.2<P2/Pt≦−0.29.

8. The objective lens of claim 7, satisfying
−2.2<P2/Pt≦−0.39.

9. The objective lens of claim 1,
wherein the first lens group comprises a glass, and
the optical surface closest to the light source in the first lens group is polished spherically.

10. The objective lens of claim 1,
wherein each of the plurality of lens groups consists of one lens.

11. An optical pickup apparatus for reproducing information from an optical information recording medium including a recording layer and a guide layer or writing information to the optical information recording medium, the optical pickup apparatus comprising:
the objective lens of claim 1 adopted to form a holographic image on the recording layer and to form a spot image on the guide layer.

12. An optical pickup apparatus for reproducing information from an optical information recording medium including a recording layer or writing information to the optical information recording medium using holography caused by a reference light and an object light, the optical pickup apparatus comprising:
a first light source for emitting a first light flux with a wavelength λ1;
a collimating lens for collimating the first light flux emitted from the first light source;
a first light splitting element for generating the reference light to be emitted on the recording layer out of the first light flux emitted by the collimating lens;
a spatial light modulator for generating the object light from the first light flux emitted by the collimating lens;
the objective lens of claim 1, adopted to converge the object light on the recording layer so as to form a holographic image on the recording layer using the object light and the reference light;
a second light splitting element arranged on an optical path between the objective lens and the spatial light modulator for splitting out the first light flux reflected by the recording layer; and
a photodetector for receiving the first light flux split out by the second light splitting element and for outputting information recorded on the recording layer.

13. An optical pickup apparatus for reproducing information from an optical information recording medium including a recording layer and a guide layer or writing information to the optical information recording medium using holography caused by a reference light and an object light, the optical pickup apparatus comprising:
a first light source for emitting a first light flux with a wavelength λ1;
a second light source for emitting a second light flux with a wavelength λ2;
a collimating lens for collimating the first light flux emitted from the first light source;
a first light splitting element for generating the reference light to be emitted on the recording layer out of the first light flux emitted by the collimating lens;
a spatial light modulator for generating the object light from the first light flux emitted by the collimating lens;
the objective lens of claim 1, adopted
to converge the object light on the recording layer so as to form a holographic image on the recording layer using the object light and the reference light, and
to form the second light flux into a spot image on the guide layer;
a second light splitting element arranged on an optical path between the objective lens and the spatial light modulator for splitting out the first light flux reflected by the recording layer;
a first photodetector for receiving the first light flux split out by the second light splitting element and for outputting signal including information recorded on the recording layer;
a third light splitting element arranged on an optical path between the objective lens and the second light source for splitting out the second light flux reflected by the guide layer;
a second photodetector for receiving the second light flux split out by the third light splitting element and for outputting signal including information recorded on the guide layer; and
a drive device for driving the objective lens based on the signal outputted from the second photodetector.
